(19) United States
(12) Patent Application Publication
(10) Pub. No.: US 2018/0109353 A1
(43) Pub. Date: Apr. 19, 2018

(54) METHOD AND APPARATUS FOR TRANSMISSION AND RECEPTION WITH REDUCED TRANSMISSION TIME INTERVAL IN WIRELESS CELLULAR COMMUNICATION SYSTEM

(71) Applicant: Samsung Electronics Co., Ltd, Gyeonggi-do (KR)

(72) Inventors: Yongjun KWAK, Gyeonggi-do (KR); Youngbum KIM, Gyeonggi-do (KR); Jeongho YEO, Gyeonggi-do (KR); Juho LEE, Gyeonggi-do (KR)

(21) Appl. No.: 15/307,999

(22) PCT Filed: Jun. 23, 2016
(86) PCT No.: PCT/KR2016/006685

§ 371 Date: Oct. 31, 2016

(30) Foreign Application Priority Data
Jun. 26, 2015 (KR) 10-2015-0091565

(51) Int. Cl. H04L 1/00; H04L 1/18; H04W 72/12; H04L 5/00

(52) U.S. Cl. CPC H04L 1/0038; H04L 1/1812; H04L 5/0007; H04W 72/1289; H04L 5/0055; H04W 72/1273

(57) ABSTRACT

The present disclosure relates to a communication technique and a system thereof, which can combine a 5G communication system for supporting a higher data rate than that of a beyond 4G system with an IoT technology. The present disclosure may be applied to intelligent services on the basis of the 5G communication technology and IoT related technology, such as smart home, smart building, smart city, smart car, connected car, health care, digital education, smart retail, security and safety services.

A wireless communication system, in particular, a method and an apparatus for using downlink and uplink control channel transmission in a system that supports transmission/reception in a transmission timing interval that is shorter than 1 ms are provided to define physical channels that are necessary in the case of having a transmission timing interval that is shorter than 1 ms, in particular, a TTI of 1 OFDM symbol length, and to perform mapping of the physical channels on resource allocation and resource blocks.

### TECHNICAL FIELD

The present invention relates generally to a wireless communication system, and more particularly, to a method and a system for transmitting/receiving data, which can reduce a transmission timing interval.

### BACKGROUND ART

In order to meet the wireless data traffic demand that is on an increasing trend after commercialization of 4G communication system, efforts for developing improved 5G communication system or pre-5G communication system have been made. For this reason, the 5G communication system or pre-5G communication system has been called beyond 4G network communication system or post LTE system. In order to achieve high data rate, implementation of 5G communication system in a millimeter Wave (mmWave) band (e.g., like 60 GHz band) has been considered. In order to mitigate a radio wave path loss and to increase a radio wave transmission distance in the mmWave band, technologies of beam-forming, massive MIMO, Full Dimension MIMO (FD-MIMO), analog beam-forming, and large scale antenna for the 5G communication system have been discussed. Further, for system network improvement in the 5G communication system, technology developments have been made for an evolved small call, improved small cell, cloud Radio Access Network (cloud RAN), ultra-dense network, Device to Device communication (D2D), wireless backhaul, moving network, cooperative communication, Coordinated Multi-Points (CoMP), and reception interference cancellation. In addition, Hybrid FSK and QAM Modulation (FQAM) and Sliding Window Superposition Coding (SWSC), which correspond to Advanced Coding Modulation (ACM) system, and Filter Bank Multi Carrier (FBMC), Non-Orthogonal Multiple Access (NOMA), and Sparse Code Multiple Access (SCMA), which correspond to advanced connection technology, have been developed in the 5G system.

On the other hand, the Internet, which is a human centered connectivity network where humans generate and consume information, is now evolving to the Internet of Things (IoT) where distributed entities, such as things, exchange and process information. The Internet of Everything (IoE), which is a combination of the IoT technology and big data processing technology through connection with a cloud server, has emerged. As technology elements, such as sensing technology, wired/wireless communication and network infrastructure, service interface technology, and security technology have been demanded for IoT implementation, a sensor network, a Machine-to-Machine (M2M) communication, Machine Type Communication (MTC), and so forth have been recently researched. Such an IoT environment may provide intelligent Internet Technology (IT) services that create new values to human life by collecting and analyzing data generated among connected things. The IoT may be applied to a variety of fields including smart home, smart building, smart city, smart car or connected cars, smart grid, health care, smart appliances and advanced medical services through convergence and combination between existing Information Technology (IT) and various industrial applications.

Accordingly, various attempts to apply the 5G communication system to an IoT network have been made. For example, technologies of sensor network, Machine to Machine (M2M), and Machine Type Communication (MTC) have been implemented by techniques for beam-forming, MIMO, and array antennas, which correspond to the 5G communication technology. Application of the cloud RAN as the big data processing technology as described above could be an example of convergence between the 5G technology and the IoT technology.

A wireless communication system has been developed from an initial one that provides a voice-oriented service to a broadband wireless communication system that provides a high-speed and high-quality packet data service, like the communication standards, such as 3GPP High Speed Packet Access (HSPA), Long Term Evolution (LTE) or Evolved Universal Terrestrial Radio Access (E-UTRA), LTE-Advanced (LTE-A), 3GPP2 High Rate Packet Data (HRPD), Ultra Mobile Broadband (UMB), and IEEE 802.16e.

In an LTE system that is a representative example of the broadband wireless communication system as described above, a Downlink (DL) adopts an Orthogonal Frequency Division Multimplexing (OFDM) system, and an Uplink (UL) adopts a Single Carrier Frequency Division Multiple Access (SC-FDMA) system. The uplink means a wireless link for transmitting data or a control signal from a terminal (or User Equipment (UE) or Mobile Station (MS)) to a Base Station (BS) (or eNode B), and the downlink means a wireless link for transmitting data or a control signal from the base station to the terminal. The above-described multiple access system divides users' data or control information through allocation and operation of time-frequency resources to carry and send the data or control information by users so that the resources do not overlap each other to establish orthogonality.

The LTE system adopts a Hybrid Automatic Repeat request (HARQ) system in which a physical layer retransmits the corresponding data if decoding failure occurs in an initial transmission stage. The HARQ system enables a receiver to transmit information for notification of the decoding failure (Negative Acknowledgement (NACK)) to a transmitter so that the transmitter can retransmit the corresponding data on a physical layer if the receiver has not decoded the data accurately. The receiver combines the data retransmitted by the transmitter with the previous data of which decoding has failed to heighten data reception performance. Further, if the receiver has accurately decoded the data, it transmits information for notification of decoding success (Acknowledgement (ACK)) to the transmitter so that the transmitter can transmit new data.

FIG. 1 is a diagram illustrating a basic structure of a time-frequency domain that is a wireless resource region in which data or a control channel is transmitted through a downlink in an LTE system.

In FIG. 1, a horizontal axis represents a time domain, and a vertical axis represents a frequency domain. The minimum transmission unit in the time domain is an OFDM symbol, and N_{symb} OFDM symbols 102 are gathered to constitute one slot 106, and two slots are gathered to constitute one subframe 105. The length of the slot is 0.5 ms, and the length of the subframe is 1.0 ms. Further, a radio frame 114 is a time domain interval that includes 10 subframes. The minimum transmission unit in the frequency domain is a subcarrier, and the transmission bandwidth of the whole system includes N_{BW} subcarriers 104 in total.

The basic unit of a resource in a time-frequency domain is a Resource Element (RE), and may be indicated by an OFDM symbol index and a subcarrier index. A Resource Block (RB) (or a Physical Resource Block (PRB)) 108 is defined by N_{symb} successive OFDM symbols 102 in the time domain and NRB successive subcarriers 110 in the frequency domain. Accordingly, one RB 108 is composed of (N_{symb}×N_{RB})-numbered REs 112. In general, the minimum transmission unit of data is the RB unit. In the LTE system, it is general that N_{symb}=7 and N_{RB}=12, and the N_{BW} and N_{RB} are proportional to the bandwidth of the system transmission band. The data rate is increased in proportion to the number of RBs that are scheduled to the terminal. In the LTE system, 6 transmission bandwidths are defined and operated. In the case of an FDD system in which the downlink and the uplink are discriminated by frequencies to be operated, the downlink transmission bandwidth and the uplink transmission bandwidth may differ from each other. The channel bandwidth indicates an RF bandwidth that corresponds to the system transmission bandwidth. Table 1 indicates a corresponding relationship between the system transmission bandwidth defined in an LTE system and the channel bandwidth. For example, the LTE system having a channel bandwidth of 10 MHz includes the transmission bandwidth that is composed of 50 RBs.

TABLE 1

| | Channel bandwidth BW_{Channel} [MHz] | | | | | |
|---|---|---|---|---|---|---|
| | 1.4 | 3 | 5 | 10 | 15 | 20 |
| Transmission bandwidth | 6 | 15 | 25 | 50 | 75 | 100 |
| configuration N_{RB} | | | | | | |

In the case of downlink control information, it is transmitted within in the first N OFDM symbols in the subframe. In general, N is N={1, 2, 3}. Accordingly, the N value is varied for each subframe in accordance with the amount of control information to be currently transmitted to the subframe. The control information includes a control channel transmission interval indicator that indicates how many OFDM symbols the control information is transmitted through, scheduling information on downlink data or uplink data, and an HARQ ACK/NACK signal.

In the LTE system, the scheduling information on the downlink data or the uplink data is transferred from a base station to a terminal through Downlink Control Information (DCI). The DCI defines several formats, and applies and operates a determined DCI format in accordance with whether the DCI is scheduling information (UL grant) on the uplink data or scheduling information (DL grant) on the downlink data, whether the DCI is a compact DCI having a small size of the control information, whether the DCI applies spatial multiplexing using multiple antennas, and whether the DCI is a DCI for power control. For example, DCI format 1 that is the scheduling control information (DL grant) on the downlink data is configured to include at least the following pieces of control information.
Resource allocation type 0/1 flag: This reports whether a resource allocation type is type 0 or type 1. Type 0 allocates resources in the unit of a Resource Block Group (RBG) through application of a bitmap method. In the LTE system, the basic unit of scheduling is RB that is expressed by time and frequency domain resources, and the RBG is composed of a plurality of RBs to configure the basic unit of scheduling in type 0. Type 1 allocates a specific RB in the RBG.
Resource block assignment: this reports the RB that is allocated for data transmission. The expressed resource is determined in accordance with the system bandwidth and the resource allocation method.
Modulation and Coding Scheme (MSC): This reports a modulation scheme that is used for data transmission and the size of a transport block that is data to be transmitted.
HARQ process number: this reports a HARQ process number.
New data indicator: This reports whether transmission is HARQ initial transmission or retransmission.
Redundancy version: This reports an HARQ redundancy version.
Transmit Power Control (TPC) command for Physical Uplink Control Channel (PUCCH): this reports a transmit power control command for a PUCCH that is an uplink control channel.

The DCI passes through a channel coding and modulation process, and is transmitted through a Physical Downlink Control Channel (PDCCH) that is a downlink physical control channel (or control information, hereinafter mixedly used) or Enhanced PDCCH (EPDCCH) (or enhanced control information, hereinafter mixedly used.

In general, the DCI is scrambled with a specific Radio Network Temporary Identifier (RNTI) (or terminal identifier) independently with respect to each terminal, channel-coded with addition of a Cyclic Redundancy Check (CRC), and then configured as an independent PDCCH to be transmitted. In the time domain, the PDCCH is mapped and transmitted for the control channel transmission interval. The frequency domain mapping location of the PDCCH is determined by an Identifier (ID) of each terminal, and is spread over the whole system transmission band.

The downlink data is transmitted through a Physical Downlink Shared Channel (PDSCH) that is a physical channel for downlink data transmission. The PDSCH is transmitted after the control channel transmission interval, and the scheduling information thereof, such as detailed mapping location in the frequency domain and modulation scheme, is notified by the DCI that is transmitted through the PDCH.

Through an MCS that is composed of 5 bits among the control information configuring the DCI, the base station reports the modulation scheme that is applied to the PDSCH to be transmitted to the terminal and the size of data (Transport Block Size (TBS)) to be transmitted. The TBS corresponds to the data size before channel coding for error correction is applied to the data (Transport Block (TB)) to be transmitted by the base station.

The modulation schemes supported in the LTE system are Quadrature Phase Shift Keying (QPSK), 16 Quadrature Amplitude Modulation (QAM), and 64 QAM, and respective modulation orders Qm correspond to 2, 4, and 6, respectively.

FIG. 2 is a diagram illustrating an example of a transmission structure of a time-frequency domain of PUCCH in an LTE_A system. In other words, FIG. 2 is a diagram illustrating the transmission structure of the time-frequency domain of the Physical Uplink Control Channel (PUCCH) that is a physical control channel for transmitting Uplink Control Information (UCI) from a terminal to a base station in an LTE-A system, which is a wireless resource region in which data or a control channel is transmitted through a downlink in an LTE system.

The UCI includes at least one of the following pieces of control information.
HARQ-ACK: If there exists no error in downlink data that the terminal has received from the base station through a Physical Downlink Shared Channel (PDSCH) that is a downlink data channel to which the Hybrid Automatic Repeat Request (HARQ) is applied, Acknowledgement (ACK) is fed back, whereas if there exists an error, Negative Acknowledgement (NACK) is fed back.
Channel Status Information (CSI): This includes a signal that indicates a Channel Quality Indicator (CQI), Precoding Matrix Indicator (PMI), Rank Indicator (RI), or channel coefficient. The base station satisfies a predetermined data reception performance by setting the Modulation and Coding Scheme (MCS) for data to be transmitted to the terminal to an appropriate value through the CSI that is acquired from the terminal. The CQI indicates a Signal to Interference and Noise Ratio (SINR) for the wideband or subband of the system, and is generally expressed in the form of the MCS for satisfying the predetermined data reception performance. PMI/RI provides precoding and rank information that is required when the base station transmits data through multiple antennas in a system that supports Multiple Input Multiple Output (MIMO). A signal that indicates a downlink channel coefficient provides relatively more detailed channel status information than that of the CSI signal, but increases uplink overhead. Here, the terminal receives in advance a report on a reporting mode that indicates what information is to be fed back, resource information on what resource is to be used, and CSI setting information on a transmission interval from the base station through higher layer signaling. Further, the terminal transmits the CSI to the base station using the pre-reported CSI setting information.

Referring to FIG. 2, a horizontal axis represents a time domain, and a vertical axis represents a frequency domain. The minimum transmission unit in the time domain is a SC-FDMA symbol 201, and N_{symb}^{UL} SC-FDMA symbols are gathered to constitute one slot 203 and 205. Further, two slots are gathered to constitute one subframe 207. The minimum transmission unit in the frequency domain is a subcarrier, and the transmission bandwidth 209 of the whole system includes N_{BW} subcarriers in total. The N_{BW} has a value in proportion of the system transmission bandwidth.

The basic unit of a resource in a time-frequency domain is a Resource Element (RE), and may be defined by an SC-FDMA symbol index and a subcarrier index. A Resource Block (RB) 211 and 217 is defined by N_{symb}^{UL} successive SC-FDMA symbols in the time domain and N_{sc}^{RB} successive subcarriers 110 in the frequency domain. Accordingly, one RB 108 is composed of (N_{symb}^{UL}×N_{sc}^{RB})-numbered REs 112. In general, the minimum transmission unit of data or control information is the RB unit. In the case of the PUCCH, it is mapped on the frequency domain that corresponds to 1 RB, and is transmitted for one subframe.

Referring to FIG. 2, specifically, it is exemplified that N_{symb}^{UL}=7 and N_{sc}^{RB}=12, and the number of Reference Signals (RSs) for channel estimation in one slot is N_{RS}^{PUCCH}=2. The RS uses Constant Amplitude Zero Auto-Correlation (CAZAC) sequence. The CAZAC sequence is featured so that its signal strength is constant and an autocorrelation coefficient is 0. A newly configured CAZAC sequence, which is obtained by performing Cyclic Shift (CS) with respect to a specific CAZAC sequence as much as a value that is larger than the delay spread of a transmission path, maintains orthogonality with respect to the original CAZAC sequence. Accordingly, a cyclic-shifted CAZAC sequence that maintains L orthogonalities at maximum can be generated from the CAZAC sequence having a length of L. The length of the CAZAC sequence that is applied to the PUCCH is 12 that corresponds to the number of subcarriers that constitute one RB.

The UCI is mapped on the SC-FDMA symbol on which the RS is not mapped. FIG. 2 illustrates an example in which 10 UCI modulation symbols 213, 215; d(0) to d(9) are mapped on SC-FDMA symbols in one subframe. The respective UCI modulation symbols are multiplied by the CAZAC sequence to which a specific cyclic shift value is applied for being multiplexed with the UCI of another terminal, and then are mapped on the SC-FDMA symbols. Frequency hopping in the unit of a slot is applied to the PUCCH in order to obtain frequency diversity. Further, the PUCCH is located on the outline of the system transmission band, and data transmission becomes possible in the remaining transmission band. That is, the PUCCH is mapped on an RB 211 that is located on the outermost line of the system transmission band at the first slot in the subframe, and is mapped on an RB 217 that is a frequency domain different from the RB 211 that is located on the other outermost line of the system transmission band at the second slot. In general, the mapping RB locations of the PUCCH for transmitting HARQ-ACK and the PUCCH for transmitting the CSI do not overlap each other.

In the LTE system, the timing relationship is defined between PUCCHs or PUSCHs that are uplink physical channels through which HARQ ACK/NACK corresponding to the PDSCH that is a physical channel for transmitting downlink data or the PUCCH/EPDDCH including Semi-Persistent Scheduling release (SPS release) are transmitted. As an example, In the LTE system that operates as a Frequency Division Duplex (FDD), the HARQ ACK/NACK that correspond to the PDSCH transmitted at the (n-4)-th subframe or the PDCCH/EPDCCH including the SPS release are transmitted to the PUCCH or PUSCH at the n-th subframe.

In the LTE system, the downlink HARQ adopts an asynchronous HARQ system in which data retransmission time is not fixed. That is, if the HARQ NACK is fed back from the terminal with respect to the initially transmitted data that is transmitted by the base station, the base station freely determines the transmission time of the retransmitted data through the scheduling operation. For the HARQ operation, the terminal buffers data that is determined as an error as the result of decoding the received data, and then combines the buffered data with next retransmitted data.

In the LTE system, unlike the downlink HARQ, the uplink HARQ adopts a synchronous HARQ system in which data retransmission time is fixed. That is, the uplink/downlink timing relationship between a Physical Uplink Shared Channel (PUSCH) that is a physical channel for transmitting uplink data, a PDCCH that is a preceding downlink control channel, and a Physical Hybrid Indicator Channel (PHICH) that is a physical channel through which downlink HARQ ACK/NACK corresponding to the PUSCH are transmitted is fixed in accordance with the following rule.

If the PDCCH including uplink scheduling control information that is transmitted from the base station or the PHICH through which downlink HARQ ACK/NACK are transmitted is received at subframe n, the terminal transmits uplink data corresponding to the control information through the PUSCH at subframe (n+k). In this case, the term “k” is differently defined in accordance with the FDD or Time Division Duplex (TDD) of the LIE system and settings thereof. As an example, in the case of the FDD LIE system, “k” is fixed to 4.

Further, if the terminal receives the PHICH for carrying the downlink HARQ ACK/NACK from the base station at subframe i, the PHICH corresponds to the PUSCH that is transmitted by the terminal at subframe i-k. In this case, “k” is defined differently from the FDD or Time Division Duplex (TDD) of the LIE system in accordance with the settings thereof.

One of important bases of cellular wireless communication system is packet data latency. For this, signal transmission/reception is performed in the unit of a subframe having a Transmission timing interval (TTI) of 1 ms in the LTE system. The LTE system that operates as described above can support a terminal having the TTI that is shorter than 1 ms (shortened-TTI/shorter-TTI UE). The shortened-TTI terminal is expected to be suitable to a Voice over LIE (VoLTE) service in which latency is important or a service such as remote control. Further, the shortened-TTI terminal is expected as a means for realizing cellular-based mission critical Internet of Things (IoT).

In the current LTE and LTE-A system, a base station and a terminal are designed so that transmission and reception are performed in the unit of a subframe of which the transmission timing interval is 1 ms. In order to support the shortened-TTI terminal that operates in the transmission timing interval that is shorter than 1 ms, it is necessary to define a transmission/reception operation that is discriminated from a general LTE and LTE-A UE. The shortest TTI length that can be physically shortened in the current LTE structure as shown in FIGS. 1 and 2 may be one symbol length. In one slot 106 (in FIG. 1) or 206 (in FIG. 2), 6 or 7 OFDM symbols or SC-FDMA symbols are included (hereinafter, the OFDM symbol and the SC-FDMA symbol are representatively unified as “OFDM symbol” or “symbol”). If the respective OFDM symbols are used with one TTI, the transmission latency can be reduced most greatly. The present invention proposes a transmission/reception method that supports a TTI of 1 OFDM symbol length in an LTE system.

### DISCLOSURE OF INVENTION

### Technical Problem

The present invention has been made in order to solve the above problems, and an aspect of the present invention provides a method and an apparatus for transmission/reception using a reduced transmission timing interval in a wireless cellular communication system.

Another aspect of the present invention provides a method, an apparatus, and a system for transmission/reception, which can reduce a transmission time.

Still another aspect of the present invention provides a shortened-TTI terminal and an operation method thereof, transmission/reception method and apparatus for the shortened-TTI terminal, and a terminal, a base station, and a system, in which an existing terminal and the shortened-TTI terminal coexist, and an operation method thereof.

### Solution to Problem

In one aspect of the present invention, a method for transmitting/receiving a signal of a base station in a wireless communication system includes determining whether a terminal to be scheduled is a first type terminal or a second type terminal; generating control information based on control information for the first type terminal if the terminal is the first type terminal; and transmitting the generated control information. In this case, the length of a transmission timing interval for the first type terminal may be shorter than the length of a transmission timing interval for the second type terminal.

In another aspect of the present invention, a method for transmitting/receiving a signal of a base station in a wireless communication system includes setting a first Transmission Timing Interval (TTI) in at least one terminal; generating a downlink control channel for the at least one terminal; mapping a downlink data channel that corresponds to the downlink control channel based on a resource mapping location of the downlink control channel; and transmitting a signal that corresponds to the first TTI in which the downlink control channel and the downlink data channel are mapped on each other.

In still another aspect of the present invention, a base station in a wireless communication system includes a transceiver unit configured to transmit and receive a signal; and a control unit configured to set a first Transmission Timing Interval (TTI) in at least one terminal, to generate a downlink control channel for the at least one terminal, to perform mapping of a downlink data channel that corresponds to the downlink control channel based on a resource mapping location of the downlink control channel, and to transmit a signal that corresponds to the first TTI in which the downlink control channel and the downlink data channel are mapped on each other.

In still another aspect of the present invention, a method for transmitting/receiving a signal of a terminal in a wireless communication system includes setting a first Transmission Timing Interval (TTI); receiving a signal that corresponds to the first TTI; confirming a downlink control channel for a downlink data channel from the first signal; and decoding the downlink data channel based on a resource mapping location of the downlink control channel if the downlink control channel is confirmed.

In still another aspect of the present invention, a terminal in a wireless communication system includes a transceiver unit configured to transmit and receive a signal; and a control unit configured to set a first Transmission Timing Interval (TTI), to receive a signal that corresponds to the first TTI, to confirm a downlink control channel for a downlink data channel from the signal that corresponds to the first TTI, and to decode the downlink data channel based on a resource mapping location of the downlink control channel if the downlink control channel is confirmed.

### Advantageous Effects of Invention

In accordance with embodiments of the present invention, a method and an apparatus for transmission/reception using a reduced transmission timing interval in a wireless cellular communication system can be provided. Further, in accordance with embodiments of the present invention, a method, an apparatus, and a system for transmission/reception, which can reduce a transmission time, can be provided.

Further, in accordance with embodiments of the present invention, a shortened-TTI terminal and an operation method thereof, transmission/reception method and apparatus for the shortened-TTI terminal, and a terminal, a base station, and a system, in which an existing terminal and the shortened-TTI terminal coexist, and an operation method thereof can be provided.

### BRIEF DESCRIPTION OF DRAWINGS

FIG. 1 is a diagram illustrating a basic structure of a time-frequency domain that is a wireless resource region in which data or a control channel is transmitted through a downlink in an LTE system;

FIG. 2 is a diagram illustrating a transmission structure of a time-frequency domain of an uplink of an LTE or LTE-A system;

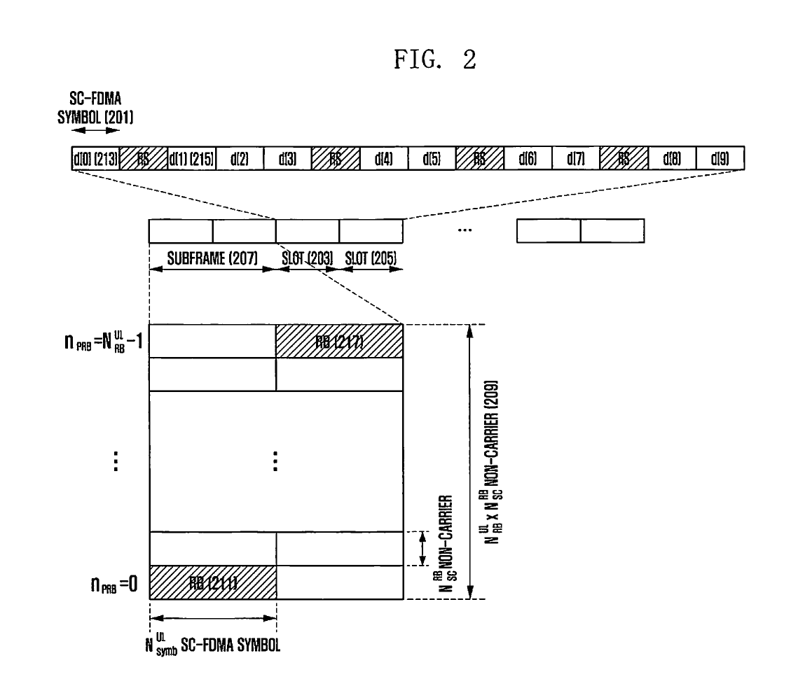

FIG. 3 is a diagram illustrating a subframe and a 1PRB structure that is a wireless resource region in which data or a control channel is transmitted through a downlink in an LTE or LTE-A system;

FIG. 4 is a diagram illustrating a resource allocation method of PDCCH and PUSCH using 1 OFDM symbol TTI according to a first embodiment of the present invention;

FIG. 5 is a diagram illustrating an operation of a terminal according to a first embodiment of the present invention;

FIG. 6 is a diagram illustrating an operation of a base station according to a first embodiment of the present invention;

FIG. 7 is a diagram illustrating a resource allocation method of PDCCH and PUSCH using 1 OFDM symbol TTI according to a second embodiment of the present invention;

FIG. 8 is a diagram illustrating an operation of a terminal according to a second embodiment of the present invention;

FIG. 9 is a diagram illustrating an operation of a base station according to a second embodiment of the present invention;

FIG. 10 is a diagram illustrating a resource allocation method of PDCCH and PUSCH using 1 OFDM symbol TTI according to a third embodiment of the present invention;

FIG. 11 is a diagram illustrating an operation of a terminal according to a third embodiment of the present invention;

FIG. 12 is a diagram illustrating an operation of a base station according to a third embodiment of the present invention;

FIG. 13 is a diagram illustrating a reverse channel structure according to an additional embodiment of the present invention;

FIG. 14 is a diagram illustrating uplink multiplexing according to a fifth embodiment of the present invention;

FIG. 15 is a diagram illustrating uplink multiplexing according to a sixth embodiment of the present invention;

FIG. 16 is a diagram illustrating uplink multiplexing according to a seventh embodiment of the present invention;

FIG. 17 is a diagram illustrating a method for transmitting 1 OFDM symbol TTI uplink of a terminal according to an additional embodiment of the present invention;

FIG. 18 is a block diagram illustrating the configuration of a terminal according to an embodiment of the present invention; and

FIG. 19 is a block diagram illustrating the configuration of a base station according to an embodiment of the present invention.

### MODE FOR THE INVENTION

Hereinafter, preferred embodiments of the present invention will be described with reference to the accompanying drawings. In describing the present disclosure, related well-known functions or configurations incorporated herein are not described in detail in the case where it is determined that they obscure the subject matter of the present disclosure in unnecessary detail. Further, terms to be described later are terms defined in consideration of their functions in the present disclosure, but may differ depending on intentions of a user and an operator or customs. Accordingly, they should be defined on the basis of the contents of the whole description of the present disclosure.

In an LTE or LTE-A system that supports a short transmission timing interval, it is necessary to define a downlink physical channel including a Physical Downlink Control Channel (PDCCH), an Enhanced Physical Downlink Control Channel (EPDCCH), a Physical Downlink Shared Channel (PDSCH), a Physical Hybrid ARQ Indicator Channel (PHICH), and a Physical Control Format Indicator Channel (PCFICH) at each transmission time, and an uplink physical channel including a Physical Uplink Control Channel (PUCCH), and a Physical Uplink Shared Channel (PUSCH), and it is necessary to define a method for transmitting an HARQ in a downlink and an uplink. According to various embodiments of the present invention, in an LTE or LTE-A system that supports a transmission timing interval of a 1 OFDM symbol length, PDCCH, EPDCCH, PDSCH, PHICH, PCFICH, PUCCH, and PUSCH at each transmission time, and a method for transmitting an HARQ in a downlink and an uplink are defined, and resource allocation method and apparatus for HARQ transmission with the above-described physical channels are provided.

Hereinafter, a base station is a subject that performs resource allocation of a terminal, and may be at least one of eNode B, Node B, Base Station (BS), wireless connection unit, base station controller, and a node on a network. A terminal may include User Equipment (UE), Mobile Station (MS), cellular phone, smart phone, computer or multimedia system that can perform a communication function. In the present invention, a Downlink (DL) means a wireless transmission path of a signal that is transmitted from the base station to the terminal, and an Uplink (UL) means a wireless transmission path of a signal that is transmitted from the terminal to the base station.

Further, although embodiments of the present invention will be hereinafter described in consideration of an LIE or LTE-A system as an example, they may also be applied to other communication systems having similar technical background or channel types. Further, the embodiments of the present invention may also be applied to other communication systems through partial modifications thereof within a range that does not greatly deviate from the scope of the invention by the judgment of those skilled in the aft.

A shortened-TTI terminal to be described hereinafter may be called a first type terminal, and a normal-TTI terminal may be called a second type terminal. The first type terminal may include a terminal having a transmission timing interval that is shorter than 1 ms, and the second type terminal may include a terminal having a transmission timing interval of 1 ms. Hereinafter, the shortened-TTI terminal and the first type terminal are mixedly used, and the normal-TTI terminal and the second type terminal are mixedly used. In an embodiment of the present invention, it is assumed that the TTI of the first type terminal is 1 OFDM symbol. However, the TTI of the first type terminal is not limited thereto, but may be applied to signal transmission having a transmission time that is shorter than 1 ms.

As described above, according to the present invention, transmission operations of the shortened-TTI terminal and the base station are defined, and a detailed method for operating the existing terminal and the shortened-TTI terminal together in the same system is proposed. In the present invention, the normal-TTI terminal indicates a terminal that transmits and receives control information and data information in the unit of 1 ms or one subframe. The control information for the normal-TTI terminal is carried on the PDCCH that is mapped on 3 OFDM symbols at maximum in one subframe to be transmitted, or is carried on the EPDCCH that is mapped on a specific resource block in the whole subframe to be transmitted. The shortened-TTI terminal indicates a terminal that can perform transmission/reception in the unit of a subframe, like the normal-TIT terminal, or in the unit that is smaller than the subframe. The shortened-TTI terminal may be a terminal that supports only transmission/reception in the unit that is smaller than the subframe.

In the LTE system, the basic resource allocation is determined by the operation of the PDCCH and PDSCH or the PDCCH and PUSCH. That is, for forward data transmission to the terminal, the base station notifies the terminal of the control information for data reception using DCI information that is included in the PDCCH, and receives the PDSCH as indicated by the DCI information. Further, for reverse data transmission to the base station, the terminal first notifies the base station of the control information for data transmission using the DCI information that is included in the PDCCH, and transmits the PUSCH as indicated by the DCI information.

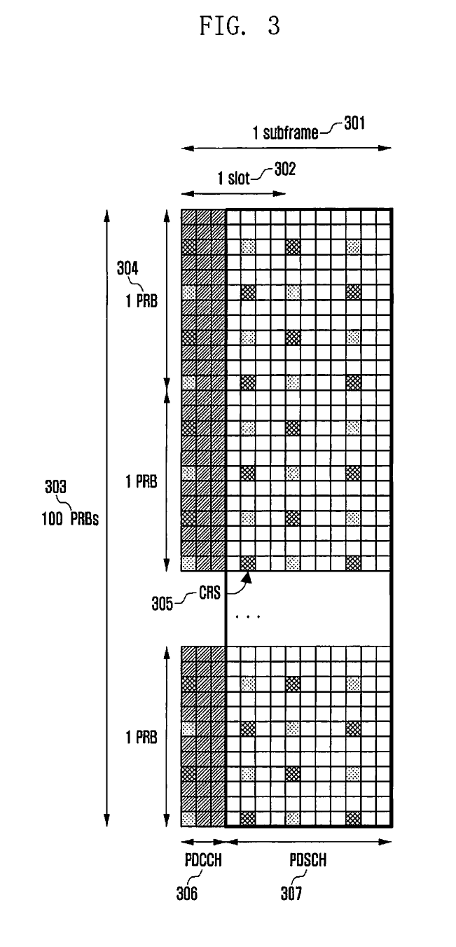

FIG. 3 is a diagram illustrating a subframe and a 1PRB structure that is a wireless resource region in which data or a control channel is transmitted through a downlink in an LTE or LTE-A system.

A structure for resource allocation and forward channel scheduling is shown in FIG. 3. Two slots 302 exist in one subframe 301, and one slot is composed of 6 or 7 OFDM symbols. One subframe corresponds to the resource allocation unit, and in the subframe, the PDCCH 306 is transmitted for the first one to four OFDM symbols, and the PDSCH 307 is transmitted for the remaining symbols. The respective symbols exist over the whole system band 303, and the frequency band is divided into Physical Resource Blocks (PRBs) 304 that correspond to a basic unit, resulting in that a plurality of PRBs exist in one system band.

A wireless resource is determined by the PRB and the OFDM symbols, and a Common Reference Signal (CRS) (or cell specific reference signal) is transmitted at a determined location like 305 in the resource. Although it is described that the PDCCH is transmitted for the first one to four OFDM symbols, the number of OFDM symbols for transmitting the PDCCH can be known through reception of the PCFICH, and the PCFICH is transmitted at the first OFDM symbol in the subframe. The terminal grasps the number of OFDM symbols for transmitting the PDCCH through reception of the PCFICH, and then performs PDCCH reception at a determined location based on the number of OFDM symbols for transmitting the PDCCH.

In the PDCCH, CRC masking has been performed using ID information of the terminal. If CRC check is successfully performed using the ID of the terminal in the PDCCH that the terminal has attempted to receive, the DCI is information that is given to the terminal having the ID, and thus the terminal having the ID can read the DCI information that is included in the PDCCH to be transmitted. The terminal that has read the DCI information determines the DCI formation based on the DCI length and information included in the DCI, and determines whether the DCI corresponds to the contents for forward PDSCH allocation or the contents for reverse PUSCH allocation.

If it is determined that the DCI format corresponds to the contents for the forward PDSCH allocation, the PDSCH at a designated resource location is received, and the PDSCH differs in accordance with the number of OFDM symbols for the PDCCH that is determined by the PDFICH. That is, the PDSCH is received at the remaining OFDM symbols excluding the OFDM symbols for the PDCCH that is designated by the PCFICH at the whole OFDM symbols that belong to one subframe. In contrast, if it is determined that the DCI format corresponds to the contents for the reverse PUSCH allocation, the PUSCH at a designated resource location is transmitted at a determined time.

One aspect of the present invention is to provide a channel structure of PDCCH and PDSCH and the operation method thereof in the case where data is transmitted or received in the TTI of one OFDM symbol length in the subframe, other than the TTI of one subframe length. The data transmission/reception operation in the TTI of one OFDM symbol length will be described using preferred embodiments described hereinafter. In the case of the TTI of one OFDM symbol, the control channel and the data channel are respectively called the PDCCH and the PUSCH, but it is assumed that they may have different structure and function from the PDCCH and PUSCH of 1 ms TTI.

### First Embodiment

In the first embodiment, it is assumed that only one terminal is scheduled in forward and reverse directions in one TTI in order to use 1 OFDM symbol TTI. In one TTI, the forward direction for one terminal and the reverse direction for one terminal may be scheduled, and the forward scheduled terminal and the reverse scheduled terminal may be the same or may be different from each other. In the case where the length of the TTI corresponds to 1 OFDM symbol, the total number of resources of the system included in the TTI is limited. Accordingly, if several terminals are simultaneously scheduled in one TTI, it is required for the several terminals to dividedly transmit/receive the limited resources, and the amount of data that is transmitted by one terminal may be insufficient. Accordingly, in this embodiment, in 1 OFDM symbol TTI, one PDSCH exists in forward direction, and only one PUSCH exists in reverse direction. Accordingly, only two PDCCHs exist at maximum in one TTI. As for possible PDCCH combinations, no PDCCH exists if no terminal is scheduled, and one PDCCH exists if one forward terminal is scheduled. Further, one PDCCH exists if one reverse terminal is scheduled, and lastly, two PDCCHs exist if one forward terminal and one reverse terminal are scheduled. The two PDCCHs become the most PDCCHs.

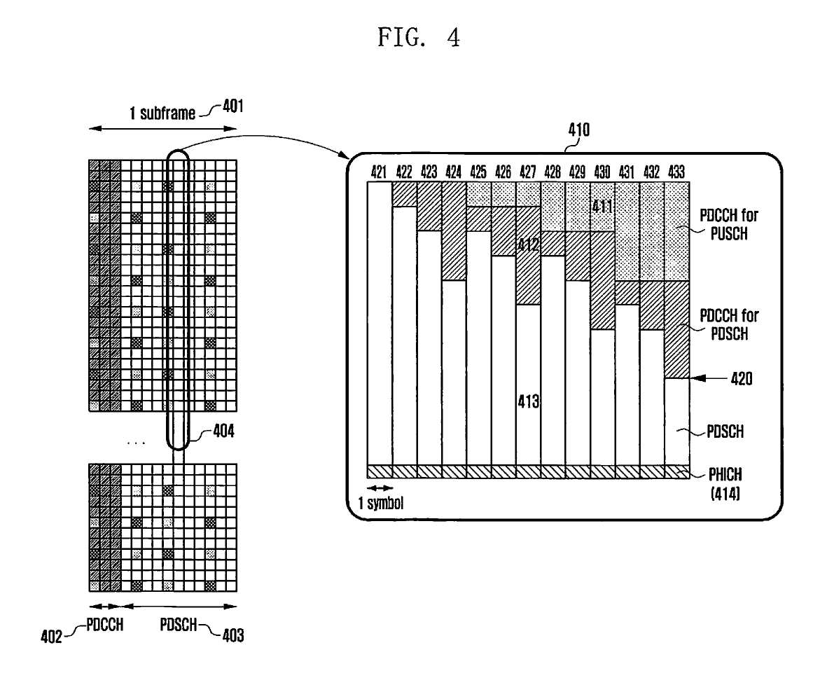

FIG. 4 is a diagram illustrating a resource allocation method of PDCCH and PUSCH using 1 OFDM symbol TTI according to a first embodiment of the present invention.

Referring to FIG. 4, in an LTE structure, one subframe 401 is divided into a PDCCH region 402 and a PDSCH region 403. Since a base station that supports 1 OFDM symbol TTI should support 1 subframe TTI terminal at the same time, it is also possible to simultaneously support 1 subframe TTI and 1 OFDM symbol TTI in the same subframe. The 1 OFDM symbol TTI may be applied to one of OFDM symbols included in the PDSCH region 403, and in a subframe in which 1 subframe TTI terminal does not exist, the 1 OFDM symbol TTI may be applied to one OFDM symbol included in the PDCCH region 402. Further, as for resources of 1 OFDM symbol TTI, partial frequency resources in one OFDM symbol are used as shown as 404 in FIG. 4, and this is to allocate the remaining frequency resources to the existing 1 ms TTI terminal. The size of the frequency resource in which 1 OFDM symbol TTI can be used may be predetermined as upper signaling or MAC signaling, and may be dynamically allocated as physical layer signaling. Of course, 1 OFDM symbol TTI may use the whole frequency resources in all.

At a certain OFDM symbol, the base station may perform PDSCH allocation with respect to one of 1 OFDM symbol support terminals, and may perform PUSCH allocation with respect to another terminal. The base station may also allocate both PDSCH and PUSCH to the same terminal. In this embodiment, it is assumed that frequency multiplexing is performed with respect to the PDCCH resource and the PDSCH resource within one symbol. In the case of 1 OFDM symbol, since the PDCCH and the PDSCH should be transmitted within one OFDM symbol, it becomes impossible to perform temporal multiplexing, and frequency multiplexing is performed. Accordingly, in one OFDM symbol, the resource for transmitting the PDCCH and the resource for transmitting the PDSCH should be divided. In this embodiment, the PDCCH resource and the PDSCH resource are dynamically divided in accordance with the use of the PDCCH, and for this, a method that can determine how the PDCCH resource and the PDSCH resource are divided is provided in accordance with PDCCH blind detection for the terminal.

Accordingly, in the PDCCH proposed according to this embodiment, both the PDCCH for forward channel allocation (PDCCH_DL) and the PDCCH for reverse channel allocation (PDCCH_UL) do not require the resource allocation information, that is, resource block assignment information. In general, information amount of resource allocation information is given a great deal of weight in the PDCCH information, and through non-transmission of the resource allocation information, the information amount of the PDCCH is reduced, and thus the PDCCH can be transmitted with less resource and with higher reliability. Of course, the PDCCH may include other pieces of information, that is, a process number that is HARQ related information, new data indicator, modulation and coding scheme information that is redundancy version or transport block related information, frequency CA related information, or power control information.

In FIG. 4, at an OFDM symbol of 404, scheduling is performed with respect to 1 OFDM symbol terminal, and PDCCH is transmitted. As described above, it is possible to put zero, one, or two PDCCHs for 1 OFDM symbol terminal in one OFDM symbol. It is possible to put one PDCCH for the PDSCH (PDCCH_DL) and one PDCCH for the PUSCH (PDCCH_UL). The PDCCH_DL and the PDCCH_UL may have different sizes, and the terminal performs blind detection based on the sizes of the PDCCH_DL and the PDCCH_UL.

In this embodiment, the PDCCH resource is first used for the PDCCH_UL transmission, and then is used for the PDCCH_DL transmission. In this embodiment, the frequency resource means a logical resource, and it is assumed that the order of the frequency resources is logically defined and the base station and the terminal share the logical order of the frequency resources. The logical frequency resources may be mapped on physical frequency resources according to a certain rule, and it is assumed that the base station and the terminal share the rule for being mapped on the physical frequency resources.

In one OFDM symbol, the base station allocates the PDCCH_UL as shown as 411 in FIG. 4 to the most preceding logical frequency resource, and allocates the PDCCH_DL as shown as 412 in FIG. 4 to the following logical frequency resource that is just behind the most preceding logical frequency resource. Further, in all the remaining portions of the whole frequency resources in which the PDCCH and the PDSCH can be used as shown as 413 in FIG. 4, the base station transmits one PDSCH. The PDCCH_UL and the PDCCH_DL have the constant number of pieces of information being transmitted, but the aggregation level of the PDCCH differs in accordance with the terminal location or the channel state.

The aggregation level means the amount of resource for transmitting the PDCCH, and in the case where the terminal is located in a place that is near to the base station and the forward channel situation is good, the terminal has no problem in receiving the PDCCH even if the PDCCH is transmitted using the minimum resource. However, in the case where the terminal is located far apart from the base station and the forward channel situation is not good, it is required to give more coding gain by increasing the amount of resource so that the terminal has no problem in receiving the PDCCH. It is assumed that a plurality of PDCCH aggregation levels are provided, and in the case of 1 OFDM symbol TTI, bit information of information that is transmitted to the PDCCH is not large, and thus the number of aggregation levels may not be large.

In this embodiment, it is assumed that three PDCCH aggregation levels are provided. That is, a terminal that has a good channel situation may transmit the PDCCH only in a certain resource unit (Control Channel Element 1 Symbol (CCE_1S)), a terminal that has a bad channel situation may transmit the PDCCH through resource mapping as many as two CCE_1S, and a terminal that has the worst channel situation may transmit the PDCCH through resource mapping as many as four CCE_1S. Since the base station optionally determines the level of the CCE_1S when transmitting the PDCCH, the terminal performs PDCCH blind detection on the assumption of all kinds of CCE_1S in receiving the PDCCH. That is, blind detection should be performed with respect to the PDCCH_UL on the assumption of three kinds of CCE_1S, and blind detection should be performed with respect to the PDCCH_DL on the assumption of three kinds of CCE_1S.

All possible PDCCH combinations in consideration of PDCCH_UL, PDCCH_DL, and CCE_1S are shown as 410 in FIG. 4. That is, 13 combinations are produced as follows. A case where no PDCCH exists (421), a case where only PDCCH_DL exists and is transmitted in 1 CCE_1S (422), a case where only PECCH_DL exists and is transmitted in 2 CCE_1S (423), a case where only PECCH_DL exists and is transmitted in 4 CCE_1S (424), a case where PDCCH_UL is transmitted in 1 CCE_1S and PDCCH_DL is transmitted in 1 CCE_1S (425), a case where PDCCH_UL is transmitted in 1 CCE_1S and PDCCH_DL is transmitted in 2 CCE_1S (426), a case where PDCCH_UL is transmitted in 1 CCE_1S and PDCCH_DL is transmitted in 4 CCE_1S (427), a case where PDCCH_UL is transmitted in 2 CCE_1S and PDCCH_DL is transmitted in 1 CCE_1S (428), a case where PDCCH_UL is transmitted in 2 CCE_1S and PDCCH_DL is transmitted in 2 CCE_1S (429), a case where PDCCH_UL is transmitted in 2 CCE_1S and PDCCH_DL is transmitted in 4 CCE_1S (430), a case where PDCCH_UL is transmitted in 4 CCE_1S and PDCCH_DL is transmitted in 1 CCE_1S (431), a case where PDCCH_UL is transmitted in 4 CCE_1S and PDCCH_DL is transmitted in 2 CCE_1S (432), and a case where PDCCH_UL is transmitted in 4 CCE_1S and PDCCH_DL is transmitted in 4 CCE_1S (433).

The terminal performs blind detection with respect to the 13 combinations as described above. Blind detections required by the terminal are as follows. First, it is assumed that no PDCCH_UL exists, and then 4 kinds of blind detections are required to perform blind detection with respect to the PDCCH_DL on the assumption of 1 CCE_1S, 2 CCE_1S, and 4 CCE_1S. Further, blind detection is performed with respect to the PDCCH_UL on the assumption of 1 CCE_1S, and then 4 kinds of blind detections are required to perform blind detection with respect to the PDCCH_DL on the assumption of 1 CCE_1S, 2 CCE_1S, and 4 CCE_1S. Further, blind detection is performed with respect to the PDCCH_UL on the assumption of 2 CCE_1S, and then 4 kinds of blind detections are required to perform blind detection with respect to the PDCCH_DL on the assumption of 1 CCE_1S, 2 CCE_1S, and 4 CCE_1S. Last, blind detection is performed with respect to the PDCCH_UL on the assumption of 4 CCE_1S, and then 4 kinds of blind detections are required to perform blind detection with respect to the PDCCH_DL on the assumption of 1 CCE_1S, 2 CCE_1S, and 4 CCE_1S. That is, 16 blind detections are required in total. In this embodiment, it is assumed that the possible number of CCE_1S is 3. However, the number of CCE_1S may be optional, and the number of blind detections to be performed by the terminal may differ in accordance with the number of CCE_1S.

Further, in this embodiment, it is assumed that PDSCH transmission resource that uses 1 OFDM symbol may be dynamically changed in accordance with the PDCCH resource. Accordingly, in the case where the PDSCH is scheduled in a certain terminal, the terminal should know to what extent the PDCCH uses the resource, and in this embodiment, the terminal determines a location at which the whole PDCCH resources are used based on the blind detection for the PDCCH_DL. That is, once the terminal performs the blind detection with respect to the PDCCH_DL, a CRC check is performed using the ID of the terminal. If the CRC check is successfully performed, it may be determined that the PDCCH_DL for the PDSCH transmission has been transmitted to the terminal. The PDCCH_DL is located at the very back of the PDCCH region in the logical frequency resource as shown as 410 in FIG. 4, and if the PDCCH_DL is received, the location at which the PDCCH region indicated by 410 and the PDSCH region are discriminated from each other can be known. Accordingly, the resource for the PDSCH is determined in the remaining region from which resources up to the last location of the PDCCH region have been subtracted in the whole resources, and accordingly, reception of the PDSCH is performed. That is, it may be determined that the resource that is located after the PSCCH region in the whole resources of symbols used in 1 OFDM symbol TTI is the resource for the PDSCH that is used in 1 OFDM symbol TTI. In the symbol that is used in the OFDM symbol UI, the terminal can know a location at which the PDCCH and the PDSCH are divided (resource, subcarrier) based on the detection of the PDCCH or a location at which the PDCCH is ended, and a location at which the PDSCH starts. Based on this, the terminal can know a start location of the PDSCH in the symbol that is used in OFDM symbol TTI, and can perform reception and decoding of the PDSCH.

In addition, transmission of the PHICH may be necessary for the HARQ operation for transmitting the PUSCH that is a reverse data channel in 1 OFDM symbol. In this case, parts of the whole resources may be allocated in advance for the PHICH channel transmission (414 in FIG. 4). Accordingly, the PDCCH is preferentially mapped on the remaining resources after presetting of the PHICH resources in the whole resources, and the last remaining resources are mapped on the PDSCH.

The CRS may exist or not in accordance with the location of the OFDM symbol. In FIG. 4, not only 404 symbols but also other symbols of the same subframe 401 may be used to transmit 1 OFDM symbol TTI. If it is assumed that the CRS structure as illustrated in FIG. 4 is used, the CRS exists at the fifth OFDM symbol and the CRS does not exist at the sixth OFDM symbol in one subframe. Accordingly, the amount of resources for transmitting the PDCCH, PDSCH, and PHICH may differ in accordance with the OFDM symbol location. Since whether to transmit the CRS is information that is shared by both the base station and the terminal, the amount of resources should be differently brought in accordance with existence/nonexistence of the CRS. Not only the CRS but also other channels for the system may exist in a certain OFDM channel, and thus the base station and the terminal should include a process of determining the amount of resources for transmitting the PDCCH, PDSCH, and PHICH in the same method. Of course, the CRS structure may be the structure as illustrated in FIG. 4, or another new CRS structure may be introduced.

Last, explanation has been made on the assumption of the logical resources, and the logical resources should be finally mapped on the physical frequency resources. There are several methods for physical resource mapping, and the easiest method is a method for mapping the logical resources on the frequency resources of the physical resources in order. That is, the mapping is performed in a manner that the first logical resource is mapped on the first physical resource and the second logical resource is mapped on the second physical resource. Another method is to perform mapping by spreading the logical resources in the physical resources to obtain frequency diversity. That is, it is also possible to map adjacent logical resources on physical resources that are maximally far apart from the logical resources, for example, in a manner that the first logical resource is mapped on the first physical resource, the second logical resource is to mapped on the 101^{st} physical resource, and the third logical resource is mapped on the 201^{st} physical resource. There may be various methods for mapping logical resources and physical resources on each other, and in this embodiment, all possible logical-physical resource mapping methods may be used.

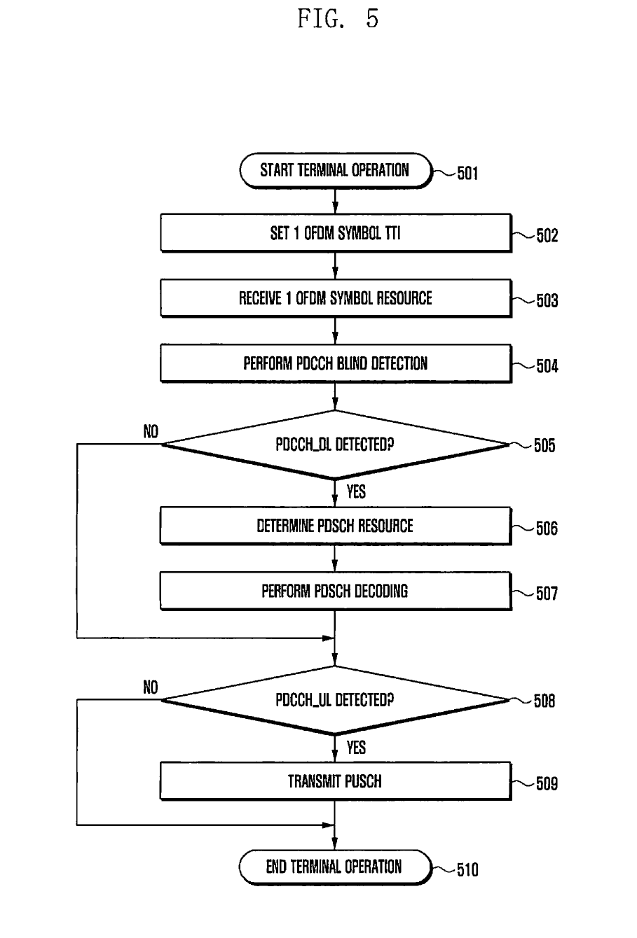

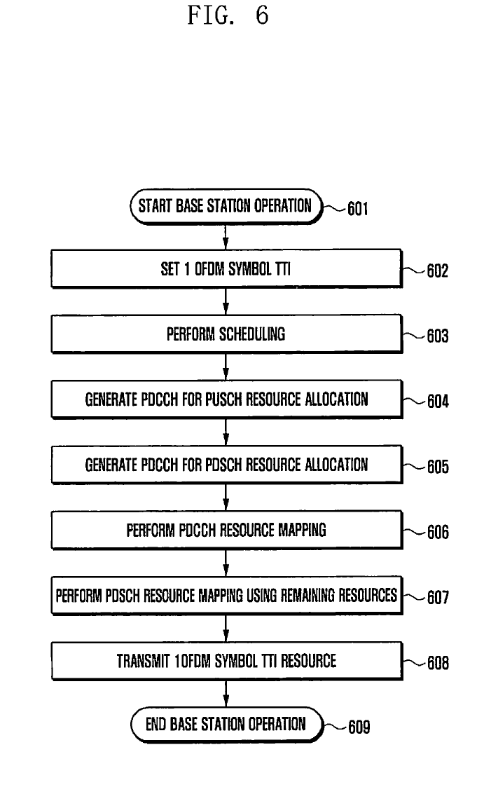

Hereinafter, using FIGS. 5 and 6, operations of a terminal and a base station according to a first embodiment of the present invention will be described.

FIG. 5 is a diagram illustrating an operation of a terminal according to a first embodiment of the present invention. Referring to FIG. 5, at operation 501, a terminal reception operation starts. At operation 502, the terminal determines whether to use 1 OFDM symbol TTI. Whether to use 1 OFDM symbol TTI may be determined in accordance with signaling between the terminal and the base station. For example, whether to use 1 OFDM symbol TTI may be determined using a System Information Block (SIB) or RRC signaling between the terminal and the base station.

Then, at operation 503, reception of 1 OFDM symbol is performed with respect to the resource set in 1 OFDM TTI. At operation 504, the terminal performs blind detection with respect to received symbols set in 1 OFDM TTI. The terminal performs blind detection with respect to all PDCCH combinations as described above with reference to FIG. 4. At operation 505, the terminal identifies whether to detect the PDCCH_DL. At operation 506, the terminal may determine the resource location of the PDSCH based on the PDCCH_DL identification at operation 505. This is because, as described above with reference to FIG. 4, the base station maps and transmits the PDSCH at a location next to the PDCCH_DL mapped resource. If the PDCCH_DL is detected, the terminal can know that the last location of the resource for transmitting the PDCCH_DL is the last location of the whole PDCCH resources. The terminal determines the resource next to the last location of the whole PDCCH resources to the last resource in the same OFDM symbol as the PDSCH resources. At operation 507, the terminal receives the PDSCH using the determined PDSCH resource. That is, the terminal may decode the PDSCH at the corresponding symbol based on the PDSCH resource location that is identified through the detection of the PDCCH.

In addition, at operation 508, the terminal identifies whether to detect the PDCCH_UL. If the terminal detects the PDCCH_UL at operation 508, the terminal proceeds to operation 509. At operation 509, at the first reverse OFDM symbol after a certain determined time, that is, after a determined TTI length, the terminal transmits the PUSCH using 1 OFDM symbol TTI. At operation 510, the terminal operation is ended.

As for the forward channel detection and reception process at operations 505 to 507 and the reverse channel detection and reception process at operations 508 and 509, FIG. 5 illustrates that the forward operation is preferentially performed and the reverse operation is performed next. However, according to the present invention, it is assumed that the forward operation and the reverse operation are performed regardless of the order. For example, the reverse operation may be first performed and the forward operation may be performed next, or the reverse operation and the forward operation may be simultaneously performed.

FIG. 6 is a diagram illustrating a base station procedure according to a first embodiment of the present invention.

Referring to FIG. 6, at operation 601, a base station first starts a base station operation. At operation 602, the base station sets 1 OFDM symbol TTI. The setting of 1 OFDM symbol TTI may be determined in accordance with signaling of the base station. For example, the base station may set 1 OFDM symbol TTI using a System Information Block (SIB) that is transmitted by the base station or RRC signaling.

Then, at operation 603, the base station determines respective channel types of a terminal to allocate PDSCH and a terminal to allocate the PUSCH through performing scheduling with respect to at least one terminal that has set 1 OFDM symbol TTI. At operation 604, the base station generates PDCCH_UL for PUSCH resource allocation. In this case, the base station configures the PDCCH_UL after determining CCE_1S as a proper value in consideration of the forward channel state of the terminal that will transmit the PDCCH_UL. For example, the base station may use 1, 2, or 4 CCE_1S in accordance with the forward channel state of the terminal. At operation 605, the base station generates PDCCH_DL for PDSCH resource allocation. In this case, the base station configures the PDCCH_DL after determining CCE_1S as a proper value in consideration of the forward channel state of the terminal that will transmit the PDCCH_DL. For example, the base station may use 1, 2, or 4 CCE_1S in accordance with the forward channel state of the terminal. On the other hand, the orders of operation 604 and operation 605 can be exchanged. That is, the base station may generate PDCCH for PUSCH resource allocation after generating the PDCCH for PDSCH resource allocation. Further, if a downlink control signal to be transmitted during operation 604 or 605 does not exist, the respective operations may be omitted.

At operation 606, the base station performs mapping of the PDCCH resource on the logical resource. The base station may use the PDCCH mapping method as described above with reference to FIG. 4. The base station first performs mapping of the PDCCH_UL on the first location of the resource for 1 OFDM symbol TTI, and then performs mapping of the PDCCH_DL onto the next location. At operation 607, the base station performs mapping of the PDSCH using the resources that remains after mapping the PDCCH on the whole resources. After PDCCH mapping, the base station may perform mapping of the PDSCH using all the remaining resources. At operation 608, the base station may transmit a mapped 1 OFDM symbol TTI symbol. Then, the base station operation is ended (609).

### Second Embodiment

In the second embodiment, it is assumed that only one terminal is scheduled in forward and reverse directions in one TIT in order to use 1 OFDM symbol TTI. In one TTI, the forward direction for one terminal and the reverse direction for one terminal may be scheduled, and the forward scheduled terminal and the reverse scheduled terminal may be the same or may be different from each other. In the case where the length of the TTI corresponds to 1 OFDM symbol, the total number of resources of the system included in the TTI is limited. Accordingly, if several terminals are simultaneously scheduled in one TTI, it is required for the several terminals to dividedly transmit/receive the limited resources, and the amount of data that is transmitted by one terminal may be insufficient. Accordingly, in this embodiment, in 1 OFDM symbol TTI, one PDSCH exists in forward direction, and only one PUSCH exists in reverse direction. Accordingly, only two PDCCHs exist at maximum in one TTI. As for possible PDCCH combinations, no PDCCH exists if no terminal is scheduled, and one PDCCH exists if one forward terminal is scheduled. Further, one PDCCH exists if one reverse terminal is scheduled, and lastly, two PDCCHs exist if one forward terminal and one reverse terminal are scheduled. The two PDCCHs become the most PDCCHs.

Even in this embodiment, since it is assumed that only one terminal is scheduled in one TTI, both the PDCCH for forward channel allocation (PDCCH_DL) and the PDCCH for reverse channel allocation (PDCCH_UL) do not require the resource allocation information, that is, resource block assignment information. In general, information amount of resource allocation information is given a great deal of weight in the PDCCH information, and through non-transmission of the resource allocation information, the information amount of the PDCCH is reduced, and thus the PDCCH can be transmitted with less resource and with higher reliability. Of course, the PDCCH may include other pieces of information, that is, a process number that is HARQ related information, new data indicator, modulation and coding scheme information that is redundancy version or transport block related information, frequency CA related information, or power control information.

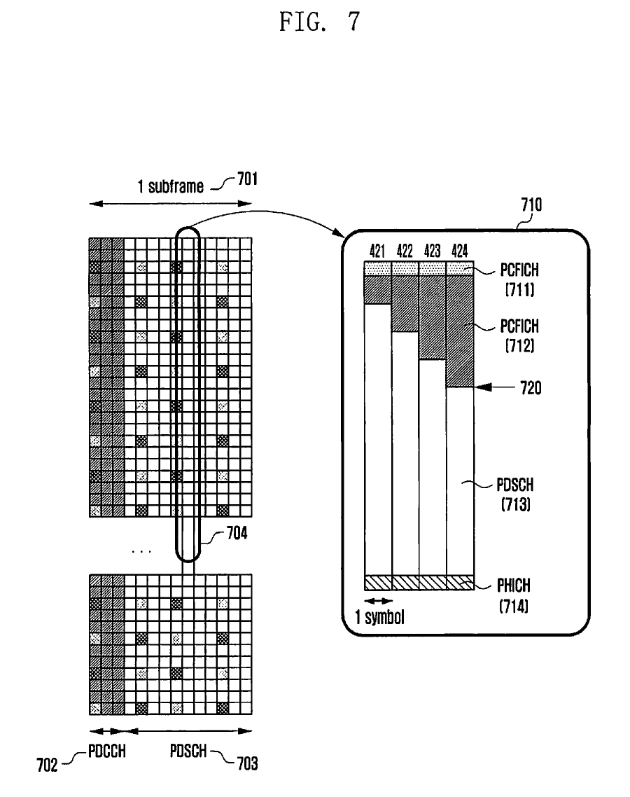

FIG. 7 is a diagram illustrating a resource allocation method of PDCCH and PUSCH using 1 OFDM symbol TTI according to a second embodiment of the present invention.

Referring to FIG. 7, a resource allocation method of PDCCH and PUSCH using 1 OFDM symbol TTI is illustrated. In an LTE structure, one subframe 701 is divided into a PDCCH region 702 and a PDSCH region 703. Since a base station that supports 1 OFDM symbol TTI should support 1 subframe TTI terminal at the same time, it is also possible to simultaneously support 1 subframe TTI and 1 OFDM symbol TTI in the same subframe. The 1 OFDM symbol TTI may be applied to one of OFDM symbols included in the PDSCH region 703, and in a subframe in which 1 subframe TTI terminal does not exist, the 1 OFDM symbol TTI may be applied to one OFDM symbol included in the PDCCH region 702.

Further, as for resources of 1 OFDM symbol TTI, partial frequency resources in one OFDM symbol are used as shown as 704 in FIG. 7, and this is to allocate the remaining frequency resources to the existing 1 ms ITT terminal. The size of the frequency resource in which 1 OFDM symbol TTI can be used may be predetermined as upper signaling or MAC signaling, and may be dynamically allocated as physical layer signaling. Of course, 1 OFDM symbol TTI may use the whole frequency resources in all.

At a certain OFDM symbol, the base station may perform PDSCH allocation with respect to one of 1 OFDM symbol support terminals, and may perform PUSCH allocation with respect to another terminal. The base station may also allocate both PDSCH and PUSCH to the same terminal. In this embodiment, it is assumed that frequency multiplexing is performed with respect to the PDCCH resource and the PDSCH resource within one symbol. In the case of 1 OFDM symbol, since the PDCCH and the PDSCH should be transmitted within one OFDM symbol, it becomes impossible to perform temporal multiplexing, and frequency multiplexing is performed. Accordingly, in one OFDM symbol, the resource for transmitting the PDCCH and the resource for transmitting the PDSCH should be divided. In this embodiment, the PDCCH resource and the PDSCH resource are dynamically divided in accordance with the use of the PDCCH, and for this, a method that can determine how the PDCCH resource and the PDSCH resource are divided is provided in accordance with PDCCH blind detection for the terminal.

In FIG. 7, at an OFDM symbol of 704, scheduling is performed with respect to 1 OFDM symbol terminal, and PDCCH is transmitted. As described above, it is possible to put zero, one, or two PDCCHs for 1 OFDM symbol terminal in one OFDM symbol. It is possible to put one PDCCH for the PDSCH (PDCCH_DL) and one PDCCH for the PUSCH (PDCCH_UL). The PDCCH_DL and the PDCCH_UL may have different sizes, and the terminal performs blind detection based on the sizes of the PDCCH_DL and the PDCCH_UL.

In this embodiment, a method for setting the PDCCH resources and transmitting the PDCCH in the set resources is proposed. In this embodiment, the frequency resource means a logical resource, and it is assumed that the order of the frequency resources is logically defined and the base station and the terminal share the logical order of the frequency resources. The logical frequency resources may be mapped on physical frequency resources according to a certain rule, and it is assumed that the base station and the terminal share the rule for being mapped on the physical frequency resources.

In one OFDM symbol, the base station allocates physical channels as shown as 710 in FIG. 7. The base station allocates PCFICH 711 and PHICH 714 to determined resource locations, and allocates PDCCH and PDSCH to the remaining resources. The resources of the PDCCH and PDSCH may divide the resources allocated by the PCFICH. The amount of PDCCH resources is determined in consideration of the number of necessary PDCCHs and the size of CCE_1S, and a location 720 at which the resources are divided is determined and notified through the PCFICH. In this embodiment, the PCFICH may be an indicator that indicates a location (resource, subcarrier) at which the PDCCH and the PDSCH are divided in 1 OFDM symbol TTI or at least one of a location at which the PDCCH is ended and a location at which the PDSCH starts.

In this embodiment, it is assumed that the PCFICH is composed of 2 bits, and thus 4 kinds of PDCCH resources as shown as 721, 722, 723, and 724 may be determined in accordance with the PCFICH information. Of course; the size of the PCFICH and the number of possible PDCCH resource regions may be determined with different values. If they have different numbers, the number of bits of the PCFICH may become larger. For example, the number of possible PDCCH resource regions may be determined based on the number of possible blind decoding cases. In this embodiment, it is assumed that the PCFICH information is transmitted as a physical layer signal. However, other methods, such as a method for predetermining the PCFICH information by upper signaling, a method for determining the PCFICH information as one value in the standards, and a method for determining the PCFICH information by MAC signaling, may also be used.

The CRS may exist or not in accordance with the location of the OFDM symbol. In FIG. 7, not only 704 symbols but also other symbols of the same subframe 701 may be used to transmit 1 OFDM symbol TTI. If it is assumed that the existing CRS structure is used as it is, the CRS exists at the fifth OFDM symbol and the CRS does not exist at the sixth OFDM symbol in one subframe. Accordingly, the amount of resources for transmitting the PDCCH, PDSCH, and PHICH may differ in accordance with the OFDM symbol location. Since whether to transmit the CRS is information that is shared by both the base station and the terminal, the amount of resources should be differently brought in accordance with existence/nonexistence of the CRS. Not only the CRS but also other channels for the system may exist in a certain OFDM channel, and thus the base station and the terminal should include a process of determining the amount of resources for transmitting the PDCCH, PDSCH, and PHICH in the same method. Of course, the CRS structure may be the structure as illustrated in FIG. 7, or another new CRS structure may be introduced.

Last, explanation has been made on the assumption of the logical resources, and the logical resources should be finally mapped on the physical frequency resources. There are several methods for physical resource mapping, and the easiest method is a method for mapping the logical resources on the frequency resources of the physical resources in order. That is, the mapping is performed in a manner that the first logical resource is mapped on the first physical resource and the second logical resource is mapped on the second physical resource. Another method is to perform mapping by spreading the logical resources to in the physical resources to obtain frequency diversity. That is, it is also possible to map adjacent logical resources on physical resources that are maximally far apart from the logical resources, for example, in a manner that the first logical resource is mapped on the first physical resource, the second logical resource is mapped on the 101^{st} physical resource, and the third logical resource is mapped on the 201^{st} physical resource. There may be various methods for mapping logical resources and physical resources on each other, and in this embodiment, all possible logical-physical resource mapping methods may be used.

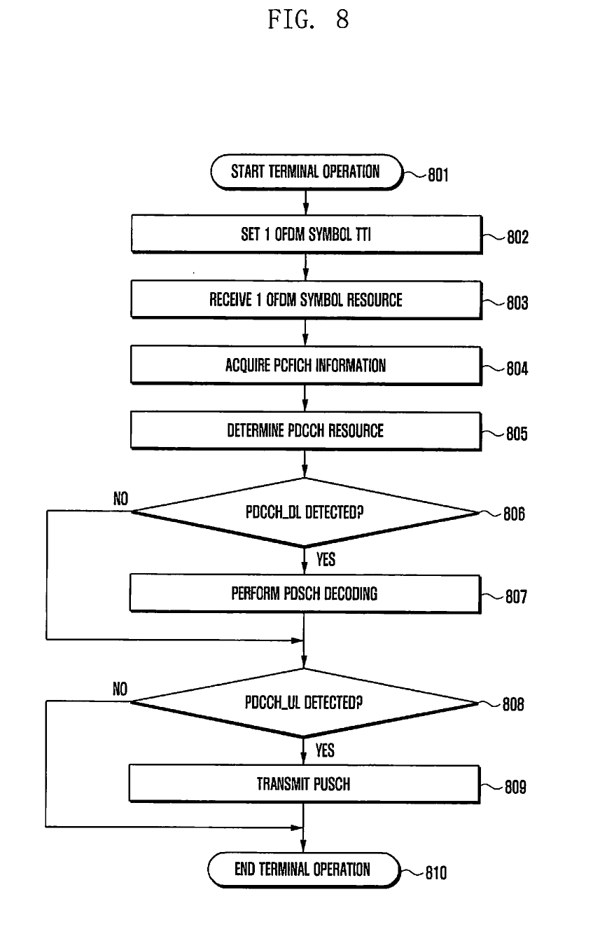

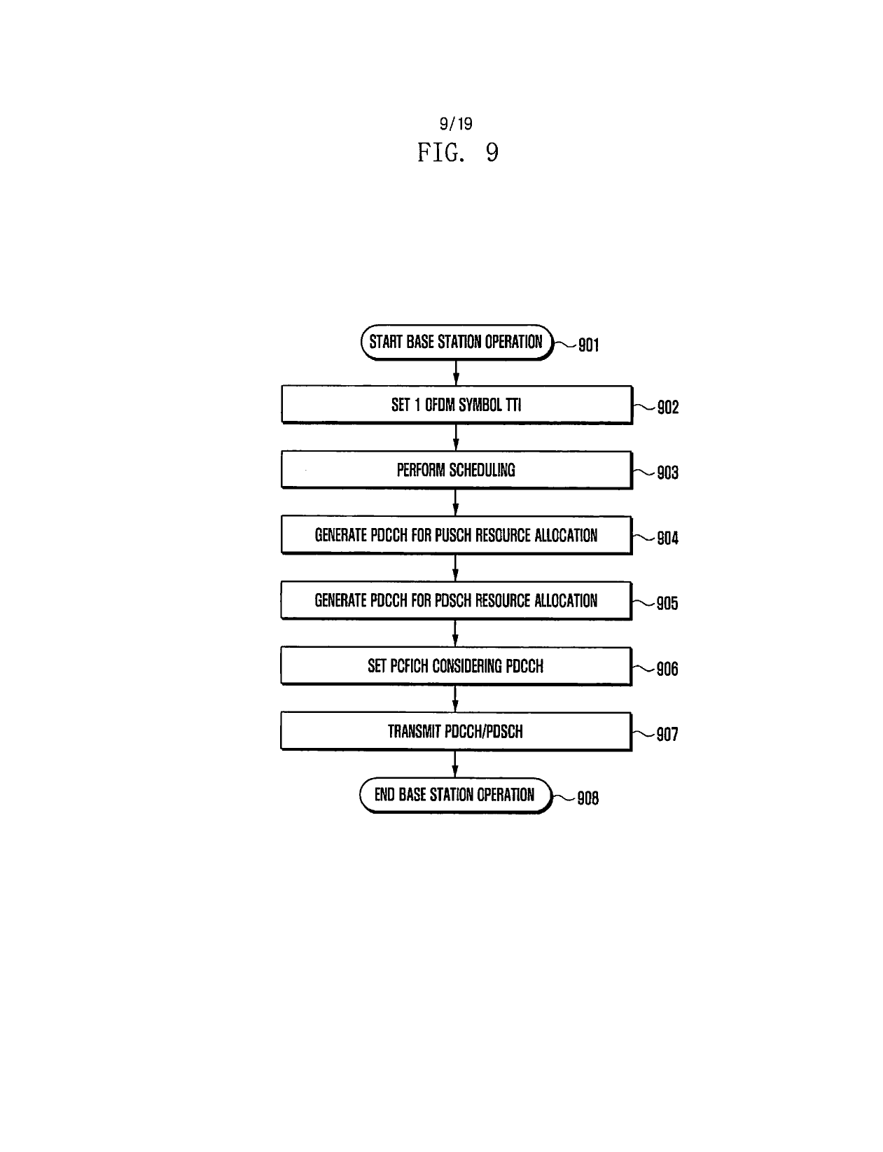

Hereinafter, using FIGS. 8 and 9, operations of a terminal and a base station will be described.

FIG. 8 is a diagram illustrating an operation of a terminal according to a second embodiment of the present invention.

Referring to FIG. 8, at operation 801, a terminal reception operation starts. At operation 802, the terminal determines whether to use 1 OFDM symbol TTI. Whether to use 1 OFDM symbol TTI may be determined in accordance with signaling between the terminal and the base station. For example, whether to use 1 OFDM symbol TTI may be determined using a System Information Block (SIB) or RRC signaling between the terminal and the base station.

Then, at operation 803, reception of 1 OFDM symbol is performed with respect to the resource set in 1 OFDM TTI. At operation 804, the terminal may acquire indicator information for dividing a PDCCH resource region and a PDSCH resource region in the received 1 OFDM symbol. The indicator may be the PCFICH. At operation 805, the terminal determines the PDCCH resource region. The terminal may determine the PDCCH resource region based on the PCFICH. Determination of the PDCCH resource region may include determination of a location of the last resource allocated to the PDCCH, a location of the start resource allocated to the PDSCH, and a location (resource, subcarrier) at which the PDCCH resource and the PDSCH resource are discriminated from each other. As described above, The PCFICH process at operation 804 may be omitted in the case where the determination of the resource allocated to the PDCCH is not performed through the PCFICH, but was determined prior to the determination through the PCFICH.

Then, at operation 806, the terminal determines existence/nonexistence of the PDCCH_DL transmitted to the terminal by performing blind detection with respect to the PDCCH. If the PDCCH_DL is detected, at operation 807, the terminal receives the PDSCH based on the determined PDCCH information. The location of the PDSCH resource is determined based on information that is acquired from the PCFICH. The terminal may perform reception and decoding of the PDSCH based on the PDCCH information and the PDSCH resource location.

In addition, at operation 808, the terminal identifies whether to detect the PUDCCH_UL. If the terminal detects the PUCCH_UL at operation 808, the terminal proceeds to operation 809. At operation 809, at the first reverse OFDM symbol after a certain determined time, that is, after a determined TTI length, the terminal transmits the PUSCH using 1 OFDM symbol TTI. At operation 810, the terminal operation is ended.

The forward process at operations 805 to 807 and the reverse process at operations 808 and 809 may be performed in reverse order or simultaneously.

FIG. 9 is a diagram illustrating the operation of a base station according to a second embodiment of the present invention.

Referring to FIG. 9, at operation 901, a base station first starts a base station operation. At operation 902, the base station sets 1 OFDM symbol TTI. The setting of 1 OFDM symbol TTI may be determined in accordance with signaling of the base station. For example, the base station may set 1 OFDM symbol TTI using a System Information Block (SIB) that is transmitted by the base station or RRC signaling. Then, at operation 903, the base station determines respective channel types of a terminal to allocate PDSCH and a terminal to allocate the PUSCH through performing scheduling with respect to at least one terminal that has set 1 OFDM symbol TTI. At operation 904, the base station generates PDCCH_UL for PUSCH resource allocation. In this case, the base station configures the PDCCH_UL after determining CCE_1S as a proper value in consideration of the forward channel state of the terminal that will transmit the PDCCH_UL. For example, the base station may use 1, 2, or 4 CCE_1S in accordance with the forward channel state of the terminal. At operation 905, the base station generates PDCCH_DL for PDSCH resource allocation, and in this case, the base station configures the PDCCH_DL after determining CCE_1S as a proper value in consideration of the forward channel state of the terminal that will transmit the PDCCH_DL. On the other hand, the orders of operation 904 and operation 905 can be exchanged. That is, the base station may generate PDCCH for PUSCH resource allocation after generating the PDCCH for PDSCH resource allocation. Further, if a downlink control signal to be transmitted during operation 904 or 905 does not exist, the respective operations may be omitted.

At operation 906, the base station determines the PCFICH so that the PDCCH has a resource size that is equal to or larger than that of the PDCCH in consideration of the size of the PDCCH. As described above, the PCFICH process at operation 906 may be omitted in the case where the determination of the resource allocated to the PDCCH is not performed through the PCFICH, but was determined prior to the determination through the PCFICH. At operation 907, the base station performs mapping of the PDCCH using the resource set as the PDCCH resource, and after the PDSCH mapping using the remaining resource, the base station transmit the mapped 1 OFDM symbol TTI symbol. Then, the base station operation is ended (908).

In addition, a method for the base station to notify of the resources of the PDCCH and the PDSCH that are used in 1 OFDM symbol TTI through upper signaling may be considered. In this case, the PCFICH is not necessary, and the terminal determines how the resources of the PDCCH and the PDSCH have been allocated through the upper signaling. Other processes are performed in the same manner.

### Third Embodiment

In this embodiment, it is assumed that several terminals are simultaneously scheduled in one OFDM symbol. As described above, the amount of available resources is insufficient in one OFDM symbol, and the necessity to simultaneously scheduling many terminals may disappear. Accordingly, it is not necessary to perform resource allocation in a very flexible method. Accordingly, in this embodiment, a method for determining the maximum number of possible terminals that can be simultaneously scheduled and performing scheduling and PDCCH transmission is proposed.

It is assumed that maximally N terminals are simultaneously scheduled in one OFDM symbol. The “N” value may be set as one value in the standards, and may be set in the terminals using MAC signaling and physical layer signaling. Further, the number of scheduling terminals of the PDSCH and the number of scheduling terminals of the PUSCH may be equal to or may be different from each other. For convenience in describing the present invention, it is assumed that the N value is 4 in both reverse and forward directions.

If the number of terminals that are simultaneously scheduled is set to 4, the allocated resources are also divided into 4 equal parts. Accordingly, in this embodiment, it is assumed that the resources are equally divided in accordance with the number of terminals that are simultaneously allocated, and resource allocation information is put into the PDCCH to be transmitted using the equally divided resources. By equally dividing the resources in advance, the amount of resource allocation information is minimized, and thus the PDCCH can be transmitted with a reduced amount of PDCCH information together with less resource and high reliability.

Specifically, it is possible to provide a method for indicating the resource allocated in a bitmap method of 4 bits in the PDCCH after dividing the resource allocated to the PDSCH and the PUSCH into 4 resources having the same size. That is, in the PDCCH, 4-bit resource allocation information is used, in which the first bit indicates whether to allocate the first one of the divided resources, the second bit indicates whether to allocate the second one of the divided resources, the third bit indicates whether to allocate the third one of the divided resources, and the fourth bit indicates whether to allocate the four one of the divided resources. As an example, if the bitmap of the resource allocation information is 1000, it means that only the first one of the divided resources is allocated to the terminal, and if the bitmap of the resource allocation information is 1101, only the first, the second, and the last resources are allocated to the terminal. Of course, it is also possible to allocate the whole 1 OFDM TTI frequency resource to one terminal using the bitmap of which the resource allocation information is 1111.

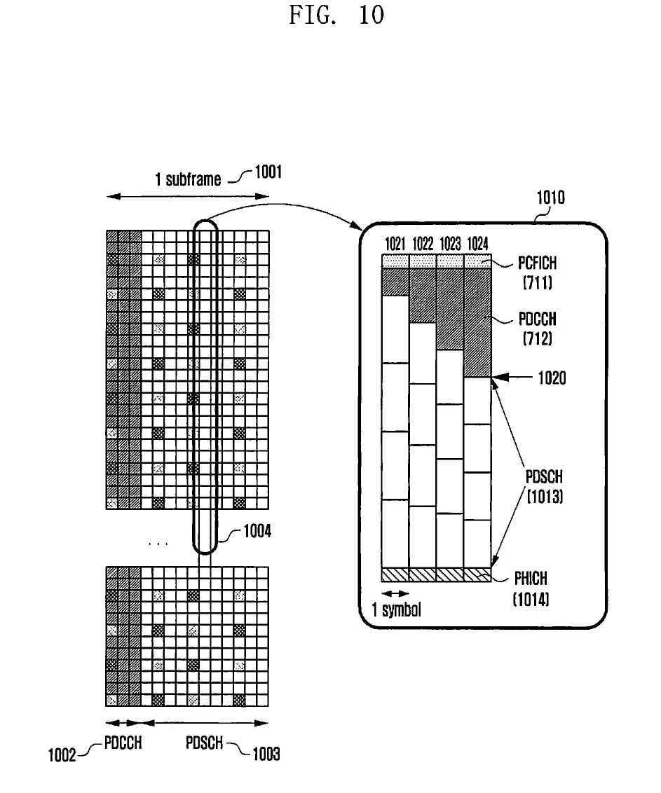

FIG. 10 is a diagram illustrating a resource allocation method of PDCCH and PUSCH using 1 OFDM symbol TTI according to a third embodiment of the present invention. In an LTE structure, one subframe 1001 is divided into a PDCCH region 1002 and a PDSCH region 1003. Since a base station that supports 1 OFDM symbol TTI should support the existing 1 subframe TTI terminal at the same time, it is also possible to simultaneously support 1 subframe TTI and 1 OFDM symbol TTI in the same subframe. The 1 OFDM symbol TTI may be applied to one of OFDM symbols included in the PDSCH region 1003, and in a subframe in which 1 subframe TTI terminal does not exist, the 1 OFDM symbol TTI may be applied to one OFDM symbol included in the PDCCH region 1002.

In FIG. 10, at an OFDM symbol of 1004, scheduling is performed with respect to 1 OFDM symbol terminal, and PDCCH is transmitted. As illustrated as 1004, partial frequency resources in one OFDM symbol are used in 1 OFDM symbol TTI, and this is to allocate the remaining frequency resources to the existing 1 ms TTI terminal. The size of the frequency resource in which 1 OFDM symbol TTI can be used may be predetermined as upper signaling or MAC signaling, and may be dynamically allocated as physical layer signaling. Of course, 1 OFDM symbol TTI may use the whole frequency resources in all.

Since plural terminals can be scheduled in 1 OFDM symbol TTI as described above, the number of PDCCHs that can be transmitted to the PDCCH region is 8 corresponding to PDCCH_DL for maximally 4 forward channels and PDCCH_UL for 4 reverse channels. The PDCCH_DL and the PDCCH_UL may have different sizes, and the terminal performs blind detection based on the sizes of the PDCCH_DL and the PDCCH_UL and the set number of terminals that can be simultaneously scheduled.

In this embodiment, the frequency resource means a logical resource, and it is assumed that the order of the frequency resources is logically defined and the base station and the terminal share the logical order of the frequency resources. The logical frequency resources may be mapped on physical frequency resources according to a certain rule, and it is assumed that the base station and the terminal share the rule for being mapped on the physical frequency resources.

In one OFDM symbol, the base station allocates physical channels as shown as 1010 in FIG. 10. The base station allocates PCFICH 1011 and PHICH 1014 to determined resource locations, and allocates PDCCH and PDSCH to the remaining resources. The resources of the PDCCH and PDSCH may divide the resources allocated by the PCFICH. The amount of PDCCH resources is determined in consideration of the number of necessary PDCCHs and the size of CCE_1S, and a location 1020 at which the resources are divided is determined and notified through the PCFICH.

In this embodiment, it is assumed that the PCFICH is composed of 2 bits, and thus 4 kinds of PDCCH resources as shown as 1021, 1022, 1023, and 1024 may be determined in accordance with the PCFICH information. Of course, the size of the PCFICH and the number of possible PDCCH resource regions may be determined with different values. In this embodiment, it is assumed that the PCFICH information is transmitted as a physical layer signal. However, other methods, such as a method for predetermining the PCFICH information by upper signaling, a method for determining the PCFICH information as one value in the standards, and a method for determining the PCFICH information by MAC signaling, may also be used.

If the PDCCH region is determined, the remaining region may be used as the PDSCH. As described above, in this embodiment, it is assumed that the PDSCH region is divided into the set number of terminals. If the PDSCH region 1013 is determined in FIG. 10, the PDSCH region is divided into N resources having the same size. In this case, N is the maximum number of terminals that can be simultaneously scheduled. In this embodiment, the PESCH region after the PDCCH region may be divided into 4 resources having the same size. The PDSCH resource region for a specific terminal may be indicated by bitmap information included in the corresponding PDCCH. The size of the divided resource may differ in accordance with the size of the PDSCH resource region. Although the forward resource has been described, the reverse PUSCH resource is divided into N resources having the same size wherein N is the maximum number of terminals that can be simultaneously scheduled with respect to the resources allocated for 1 OFDM symbol TTI. The PUSCH resource for a specific terminal may be indicated by the bitmap information included in the corresponding PUCCH.

The CRS may exist or not in accordance with the location of the OFDM symbol. If it is assumed that the existing CRS structure is used as it is, the CRS exists at the fifth OFDM symbol and the CRS does not exist at the sixth OFDM symbol in one subframe. Accordingly, the amount of resources for transmitting the PDCCH, PDSCH, and PHICH may differ in accordance with the OFDM symbol location. Since whether to transmit the CRS is information that is shared by both the base station and the terminal, the amount of resources should be differently brought in accordance with existence/nonexistence of the CRS. Not only the CRS but also other channels for the system may exist in a certain OFDM channel, and thus the base station and the terminal should include a process of determining the amount of resources for transmitting the PDCCH, PDSCH, and PHICH in the same method. Of course, the CRS structure may be the structure as illustrated in FIG. 10, or a new CRS structure may be introduced.

Last, explanation has been made on the assumption of the logical resources, and the logical resources should be finally mapped on the physical frequency resources. There are several methods for physical resource mapping, and the easiest method is a method for mapping the logical resources on the frequency resources of the physical resources in order. That is, the mapping is performed in a manner that the first logical resource is mapped on the first physical resource and the second logical resource is mapped on the second physical resource. Another method is to perform mapping by spreading the logical resources in the physical resources to obtain frequency diversity. That is, it is also possible to map adjacent logical resources on physical resources that are maximally far apart from the logical resources, for example, in a manner that the first logical resource is mapped on the first physical resource, the second logical resource is mapped on the 101^{st} physical resource, and the third logical resource is mapped on the 201^{st} physical resource. There may be various methods for mapping logical resources and physical resources on each other, and in this embodiment, all possible logical-physical resource mapping methods may be used.

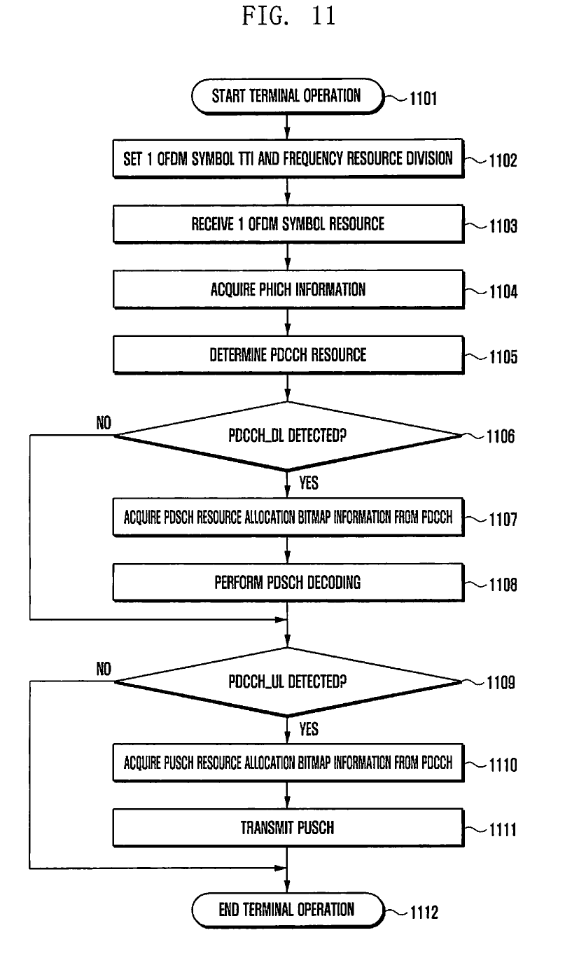

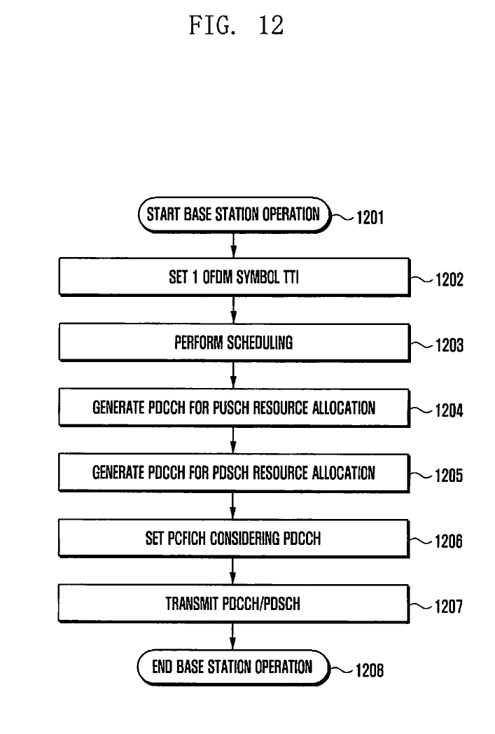

Hereinafter, using FIGS. 11 and 12, operations of a terminal and a base station according to a third embodiment will be described.

FIG. 11 is a diagram illustrating an operation of a terminal according to a third embodiment of the present invention.

Referring to FIG. 11, at operation 1101, a terminal reception operation starts. At operation 1102, the terminal determines whether to use 1 OFDM symbol TTI and, if used, the number of divided frequency resources that is determined in accordance with the maximum number of terminals that are scheduled. Whether to use 1 OFDM symbol TTI and/or the maximum number of terminals that are scheduled may be determined in accordance with signaling of the base station. For example, whether to use 1 OFDM symbol TTI and the maximum number of terminals that are scheduled may be determined using a System Information Block (SIB) or RRC signaling between the terminal and the base station.

At operation 1103, reception of 1 OFDM symbol is performed with respect to the resource set in 1 OFDM TTI. At operation 1104, the terminal may acquire indicator information for dividing a PDCCH resource region and a PDSCH resource region in the received 1 OFDM symbol. The indicator may be the PCFICH. The base station receives the PCFICH at operation 1104, and determines the PDCCH resource region at operation 1105 to receive the PDCCH. The PCFICH process at operation 1104 may be omitted in the case where the determination of the resource allocated to the PDCCH is not performed through the PCFICH, but was determined prior to the determination through the PCFICH.

At operation 1106, the terminal determines whether the PDCCH_DL is transmitted by performing blind detection with respect to the PDCCH_DL. If the PDCCH_DL is detected, at operation 1107, the terminal grasps the frequency resource for transmitting the PDSCH using bitmap type resource allocation information included in the received PDCCH. The terminal may decode the PDSCH resource by grasping the frequency resource that is acquired from the bitmap type resource allocation information in the PDSCH region that is divided by the maximum number n of schedulable terminals.

In addition, at operation 1109, the terminal identifies whether to detect the PUCCH_UL. If the terminal detects the PUCCH_UL at operation 1109, the terminal proceeds to operation 1110. At operation 1110, the terminal identifies the frequency resource for transmitting the PUSCH using the bitmap type resource allocation information included in the received PDCCH. At operation 1111, at the first reverse OFDM symbol after a certain determined time, that is, after a determined TTI length, the terminal transmits the PUSCH using 1 OFDM symbol TTI and using the determined frequency resource at operation 1111. The terminal transmits the PUSCH by grasping the frequency resource that is acquired from the bitmap type resource allocation information in the PUSCH region that is divided by the maximum number n of schedulable terminals. At operation 1112, the terminal operation is ended.

The forward operation at operations 1106 to 1108 and the reverse operation at operations 1109 to 1111 may be performed in reverse order or simultaneously.

FIG. 12 is a diagram illustrating the operation of a base station according to a third embodiment of the present invention.

Referring to FIG. 12, at operation 1201, a base station first starts a base station operation. At operation 1202, the base station sets 1 OFDM symbol TTI. Further, the base station determines whether to use the TTI, and if so, the base station determines the number of divided frequency resources that is determined in accordance with the maximum number of terminals that are scheduled. The determination of the 1 OFDM symbol TTI and the maximum number of scheduled terminals may be determined in accordance with signaling of the base station. For example, the base station may set 1 OFDM symbol TTI and/or the maximum number of scheduled terminals using a System Information Block (SIB) that is transmitted by the base station or RRC signaling.

Then, at operation 1203, the base station determines the terminal to allocate the PDSCH, the terminal to allocate the PUSCH, and the type of respective channels by performing scheduling with respect to plural terminals that have determined 1 OFDM symbol 111. At operation 1204, the base station generates PDCCH_UL for PUSCH resource allocation, and determines and includes frequency resources allocated to the terminals through a bitmap. Further, the base station configures the PDCCH_UL after determining CCE_1S as a proper value in consideration of the forward channel state of the terminal that will transmit the PDCCH_UL. At operation 1205, the base station generates PDCCH_DL for PDSCH resource allocation, and determines and includes frequency resources allocated to the terminals through a bitmap. Further, the base station configures the PDCCH_DL after determining CCE_1S as a proper value in consideration of the forward channel state of the terminal that will transmit the PDCCH_DL. On the other hand, the orders of operation 1204 and operation 1205 can be exchanged. That is, the base station may generate PDCCH for PUSCH resource allocation after generating the PDCCH for PDSCH resource allocation. Further, if a downlink control signal to be transmitted during operation 1204 or 1205 does not exist, the respective operations may be omitted.

At operation 1206, the base station determines the PCFICH so that the PDCCH has a resource size that is equal to or larger than that of the PDCCH in consideration of the size of the PDCCH. At operation 1207, the base station performs mapping of the PDCCH using the resource set as the PDCCH resource, and performs the PDSCH mapping using the remaining resource to transmit the PDSCH. Then, the base station operation is ended (1208).

In addition, a method for the base station to notify of the resources of the PDCCH and the PDSCH that are used in 1 OFDM symbol TTI through upper signaling may be considered. In this case, the PCFICH is not necessary, and the terminal determines how the resources of the PDCCH and the PDSCH have been allocated through the upper signaling. Other processes are performed in the same manner.

As described above, the PDCCH transmission method for 1 OFDM symbol TIT has been described. Hereinafter, a reverse channel structure having 1 OFDM symbol TTI is proposed.

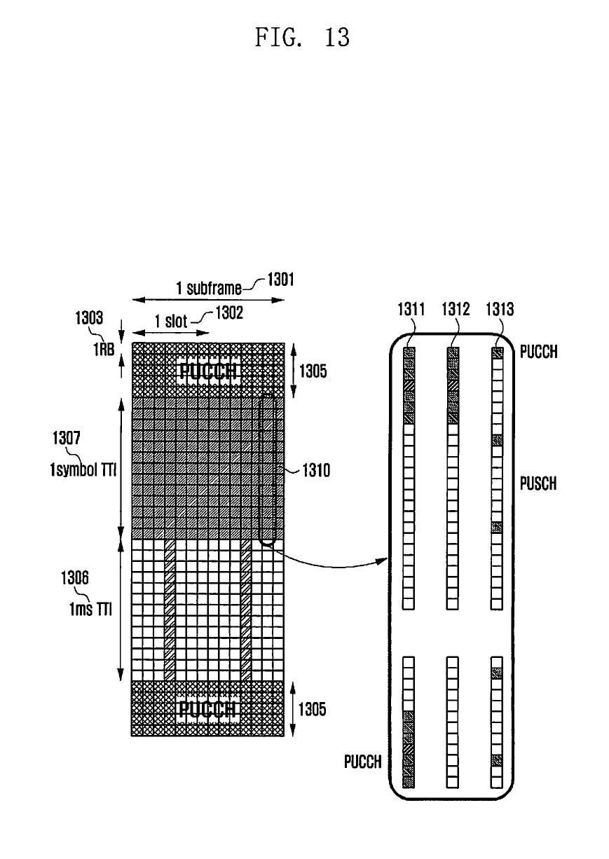

FIG. 13 is a diagram illustrating a reverse channel structure according to an additional embodiment of the present invention.

Referring to FIG. 13, on time axis, one subframe 1301 includes two slots 1302, and one slot is Jo composed of 6 or 7 OFDM symbols. 12 resource elements on frequency axis constitute one Resource Block (RB) 1303, and a plurality of RBs constitute one system. As an example, a 10 MHz system includes 50 RBs, and 20 MHz system includes 100 RBs.

The plurality of RBs 1304 and 1305 that are located at both ends of the whole frequency band are allocated as PUCCH resources that are transmitted by an existing terminal having 1 ms TTI length, and the remaining resources may be allocated as PUSCH resources that are transmitted by an existing terminal having 1 ms TTI length. It is not easy to perform dynamic allocation for the PUCCH resources 1304 and 1305, and 1 OFDM symbol TTI channel may use a resource to which the PUSCH channel can be allocated. Accordingly, a portion 1306 of a region in which the PUCCH is not transmitted is allocated with the PUSCH resource for the terminal having existing 1 ms TTI length, and the remaining resource 1307 may be allocated as the resource for 1 OFDM symbol TTI channel. In the resource of 1310, 1 OFDM symbol TTI channels may be transmitted. In the channel for transmitting 1 OFDM symbol TTI, the PUCCH for control information and the PUSCH for data information exist. Using below embodiments, a method for multiplexing the PUCCH and the PUSCH will be described.

### Fourth Embodiment

In this embodiment, a method for allocating PUCCH and PUSCH channels through frequency multiplexing in a resource that is allocated to 1 OFDM symbol TTI is proposed. FIG. 13 illustrates a possible multiplexing method. It is possible to provide a method for allocating portions at both ends of resources like 1311 to the PUCCH and allocating the remaining resource to the PUSCH within a resource 1310 allocated to 1 OFDM symbol TTI. Further, it is possible to provide a method for allocating a portion of the very first resource like 1311 to the PUCCH and allocating the remaining resource to the PUSCH. Last, it is also possible to perform mapping of the PUCCH by allocating resources at a constant interval over the whole resources of 1 OFDM symbol TTI like distributed resources and to perform mapping of the PUSCH to the remaining resource.

In the fourth embodiment, the method for multiplexing the PUCCH resource and the PUSCH resource has been described. As for the PUSCH resource, a resource on which data information is mapped and a resource on which a reference signal is mapped are required, and for multiplexing of two pieces of information, frequency multiplexing becomes necessary. For LTE reverse transmission, an SC-FDMA method is used as a method for reducing a Peak to Average Power Ratio (PAPR), and in the case of 1 OFDM symbol TTI, it may be difficult to purely adopt the SC-FDMA method, and thus a transmission method which can minimize the PAPR increase and heighten the performance becomes necessary. Through embodiments to be described below, a method capable of performing frequency multiplexing of a data signal and a reference signal as reducing the PAPR is proposed.

### Fifth Embodiment

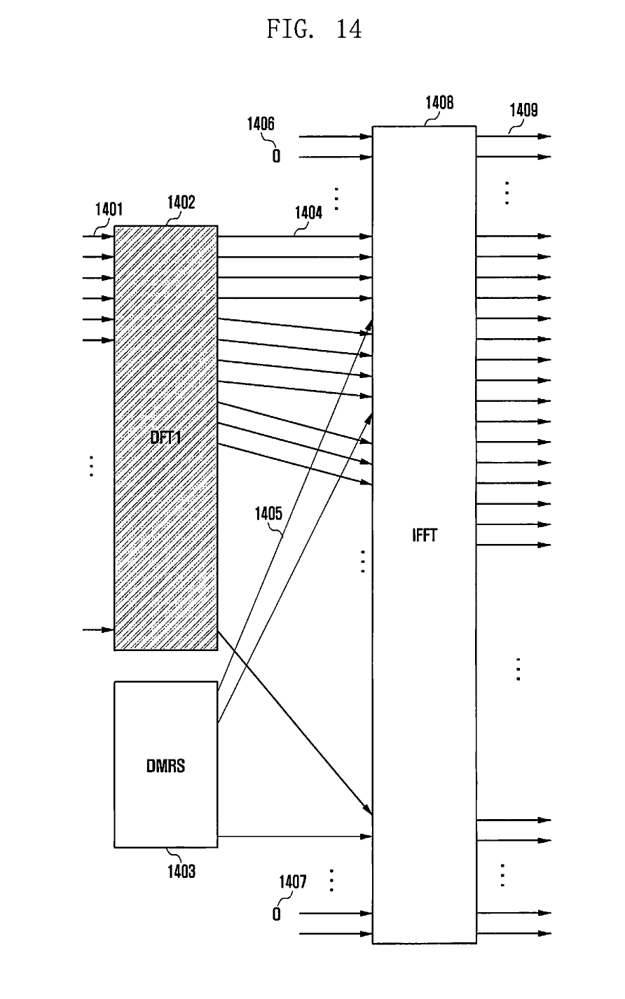

FIG. 14 is a diagram illustrating uplink multiplexing according to a fifth embodiment of the present invention.

Referring to FIG. 14, a multiplexing method for this embodiment is proposed. In FIG. 14, data (DFT input) 1401 is input to a DFT block 1402. DFT-coded output 1404 is input to an IFFT block 1408 to perform IFFT. The IFFT input is considered as a frequency domain, and in order to multiplex (iota and a reference signal on one OFDM symbol, frequency multiplexing is essential. In an uplink subframe in the related art, a reference signal is multiplexed in a time domain, but in order to multiplex the reference signal and data on one symbol in 1 OFDM symbol TTI, frequency multiplexing is essential. Accordingly, as for the IFFT input, the reference signal should be multiplexed together with the data signal.

In an embodiment of FIG. 14, the reference signal is mapped in a certain period and at a constant interval. That is, a DMRS block 1403 generates and inputs a DeModulation Reference Signal (DMRS) as an IFFT input at a constant interval together with a DMRS-coded output 1405. Referring to FIG. 14, the constant interval is described as an interval of 5 subcarriers, but the interval may be an arbitrary number. Data is mapped on 4 subcarriers, and the reference signal is mapped on one subcarrier, so that mapping can be performed at an interval of 5 subcarriers. The data signal is mapped on the remaining region on which the reference signal is mapped, and as for the IFFT input like 1404, mapping is performed to avoid the subcarrier on which the reference signal is mapped. The frequency domain for inputting the data signal and the reference signal is a frequency domain that is allocated to the terminal for PUSCH transmission, and in the remaining region, that is, in regions 1406 and 1407, “0” value is input. That is, inputs 1404, 1405, 1406, and 1407 are inputs of frequency resource sizes of the whole system. The IFFT block 1408 outputs a signal 1409 in a time domain, and the terminal successively transmits the signals 1409 in the time domain. Equation relationships are as follows.

DFT input/output: L

Whole IFFT input/output (the number of subcarriers of the whole system, for example, 1200 in the case of 20 MHz BW system): K

PUSCH allocation frequency (the number of subcarriers): M

Reference signal transmission interval: P

A relational equation for variables as described above is as follows.

L+Ceiling(M/P)=M≤K

### Sixth Embodiment

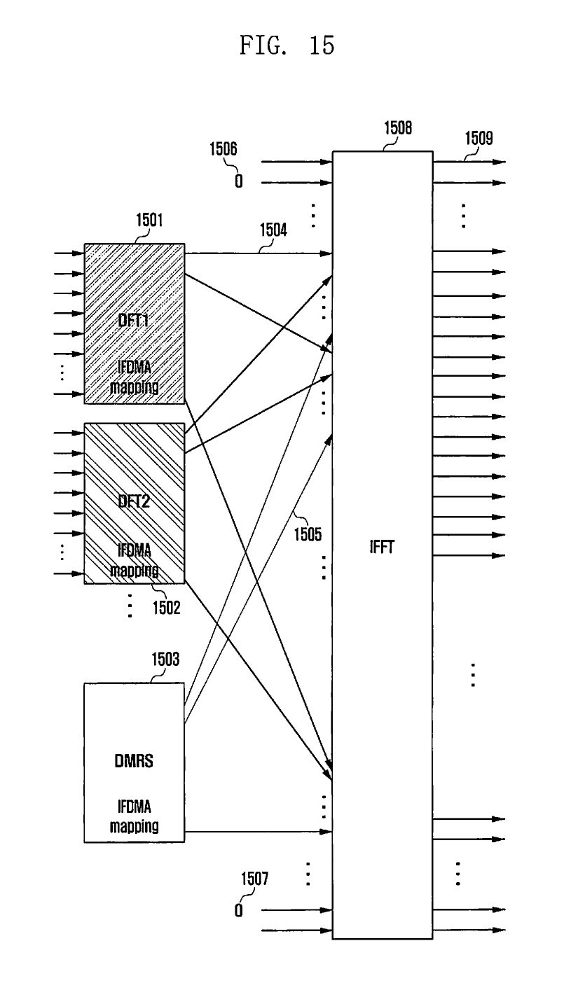

FIG. 15 is a diagram illustrating uplink multiplexing according to a sixth embodiment of the present invention.

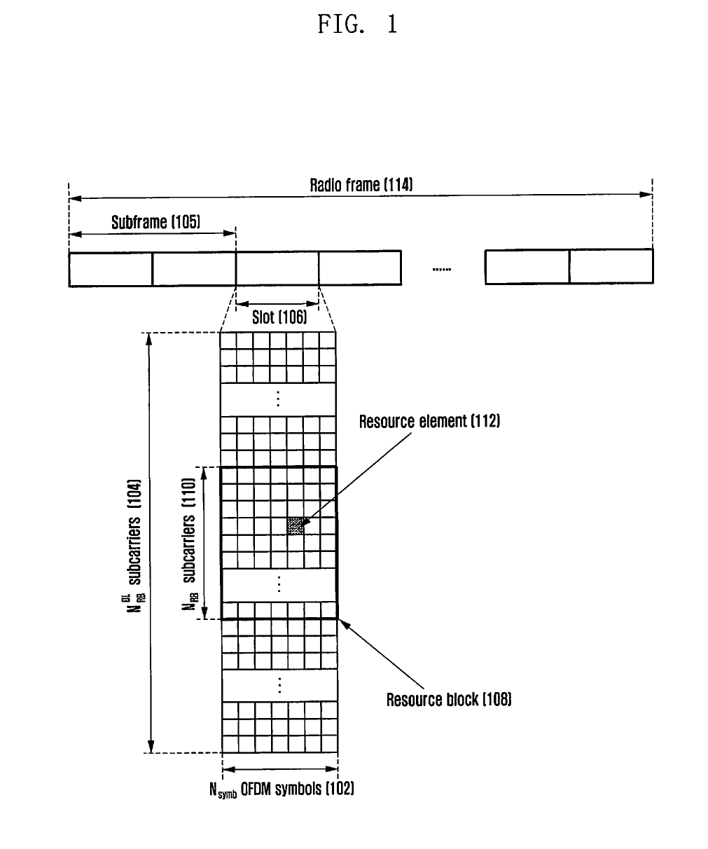

Referring to FIG. 15, a multiplexing method for this embodiment is proposed. In FIG. 1, data is input to a plurality of DFT blocks 1501 and 1502, and a DFT-coded output 1504 is input to an IFFT block 1508. One DFT output sequence has a certain period P, and performs mapping of a data signal on an IFFT input signal at a constant interval. Further, the output of the next IFFT block has the same period, and performs mapping of the data signal on the IFFT input signal.

In a DMRS block 1503, a DeModulation Reference Signal (DMRS) also has the same period P in the same manner, and is input to the IFFT block like 1505 at a constant interval. The frequency domain for inputting the data signal and the reference signal is a frequency domain that is allocated to the terminal for PUSCH transmission, and in the remaining region, that is, in regions 1506 and 1507, “0” value is input. That is, inputs 1504, 1505, 1506, and 1507 are inputs of frequency resource sizes of the whole system. The IFFT block 1508 outputs a signal 1509 in a time domain, and the terminal successively transmits the signals 1509 in the time domain. Equation relationships are as follows.

DFT input/output: L

DFT block number: N

Whole IFFT input/output (the number of subcarriers of the whole system, for example, 1200 in the case of 20 MHz BW system): K

PUSCH allocation frequency (the number of subcarriers): M

Reference signal transmission interval: P

A relational equation for variables as described above is as follows.

N=P−1

L×N+Ceiling(M/P)=M≤K

### Seventh Embodiment

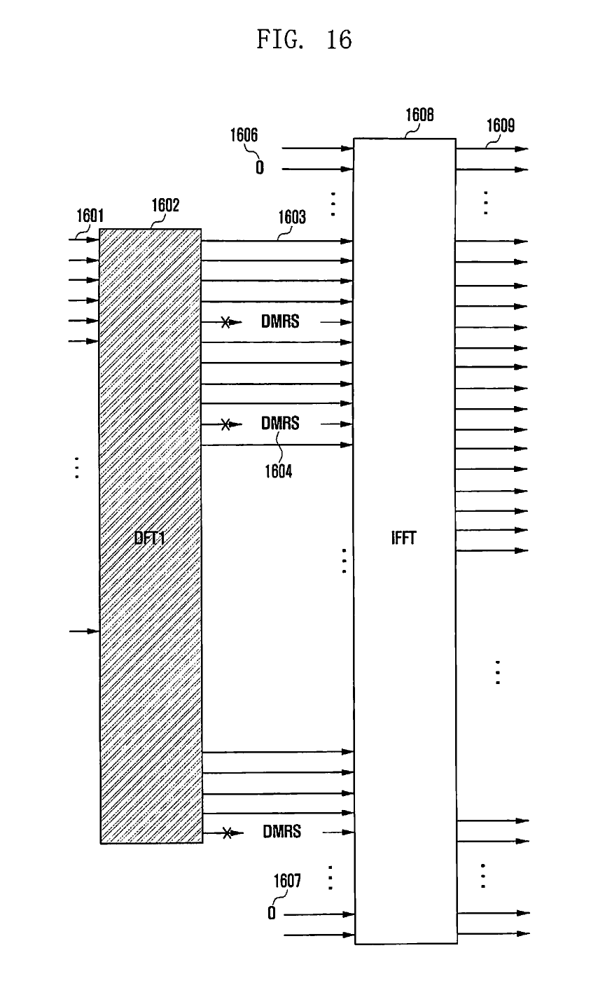

FIG. 16 is a diagram illustrating uplink multiplexing according to a seventh embodiment of the present invention.

Referring to FIG. 16, a multiplexing method for this embodiment is proposed. In FIG. 16, data is input to DFT blocks 1601 and 1602, and a DFT-coded output 1604 is input to an IFFT block 1608 to perform IFFT. In this case, the number of DFT-coded outputs 1604 is equal to the number of IFFT block inputs 1608, that is, the number of allocated subcarriers. The IFFT input is considered as the frequency domain, and in order to multiplex data and a reference signal on one OFDM symbol, frequency multiplexing is essential. Accordingly, as for the IFFT input, the reference signal should be multiplexed together with the data signal, and in an embodiment of FIG. 16, the reference signal is mapped in a certain period and at a constant interval.

That is, a DMRS block 1603 generates and inputs a DeModulation Reference Signal (DMRS) as an IFFT input at a constant interval. Referring to FIG. 16, the interval is described as an interval of 5 subcarriers, but the interval may be an arbitrary number. The data signal is not transmitted to the IFFT input terminal on which the reference signal is mapped. That is, when a DFT output of the data signal is input to the IFFT block, the data signal that corresponds to the mapped input is discarded, and the data signal is input only to the input on which the reference signal is not mapped. The frequency domain for inputting the data signal and the reference signal is a frequency domain that is allocated to the terminal, and in the remaining region, that is, in regions 1606 and 1607, “0” value is input. That is, inputs 1604, 1605, 1606, and 1607 are inputs of frequency resource sizes of the whole system. The IFFT block 1608 outputs a signal 1609 in a time domain, and the terminal successively transmits the signals 1607 in the time domain. Equation relationships are as follows.

DFT input/output: L

Whole EFT input/output (the number of subcarriers of the whole system, for example, 1200 in the case of 20 MHz BW system): K

PUSCH allocation frequency (the number of subcarriers): M

Reference signal transmission interval: P

A relational equation for variables as described above is as follows.

L=M≤K

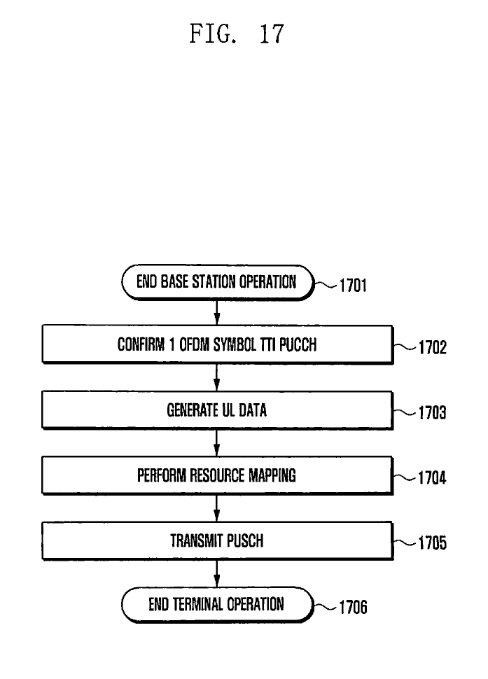

FIG. 17 is a diagram illustrating a method for transmitting 1 OFDM symbol TTI uplink of a terminal according to an additional embodiment of the present invention.

Referring to FIG. 17, at operation 1701, a terminal starts its operation. If 1 OFDM symbol TTI is set, the terminal receives PDCCH in the frequency band and symbol corresponding to the setting. At operation 1702, the terminal identifies 1 OFDM symbol TTI PUCCH for the terminal itself.

If there is not 1 OFDM symbol TTI PUCCH allocated to the terminal, the terminal ends the operation for uplink transmission. If 1 OFDM symbol TTI PUCCH allocated to the terminal is identified, at operation 1703, the terminal generates uplink data.

At operation 1704, the terminal performs mapping of the uplink data on a PUSCH resource based on the uplink scheduling information of the 1 OFDM symbol TTI PUCCH. For example, the uplink data resource mapping method as described above with reference to FIG. 14, 15, or 16 may be used.

At operation 1705, the terminal transmits PUSCH.

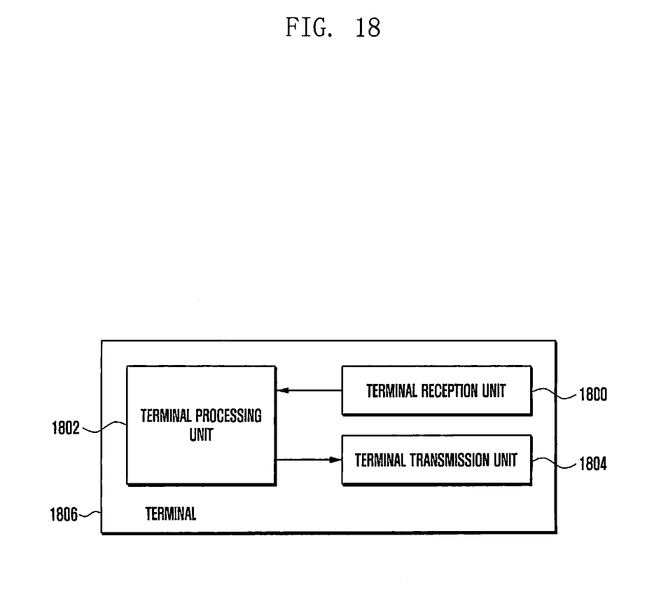

FIG. 18 is a block diagram illustrating the configuration of a terminal according to an embodiment of the present invention.

Referring to FIG. 18, a terminal 1806 according to the present invention may include a terminal reception unit 1800, a terminal transmission unit 1804, and a terminal processing unit 1802. According to an embodiment of the present invention, the terminal reception unit 1800 and the terminal transmission unit 1804 may be commonly called a transceiver unit. The transceiver unit may transmit/receive data with a base station. The signal may include at least one of control information, data, and pilot. The terminal processing unit 1802 may be called a control unit or a controller.

The transceiver unit may include an RF transmitter configured to up-convert and amplify the frequency of the transmitted signal, and an RF receiver configured to low-noise-amplify the received signal and to down-convert the frequency. Further, the transceiver unit may receive the signal through a wireless channel, output the received signal to the terminal processing unit 1802, and transmit the signal output from the terminal processing unit 1802 through a wireless channel.

According to an embodiment of the present invention, the terminal processing unit 1802 sets a Transmission Timing Interval (TTI) that is smaller than 1 subframe, receives a TTI resource that is smaller than 1 subframe, confirms a downlink control channel for a downlink data channel from the TTI resource that is smaller than the 1 subframe, and decodes the downlink data channel based on the resource mapping location of the downlink control channel if the downlink control channel is confirmed. The TTI that is smaller than the 1 subframe may be called a first TTI.

The TTI that is smaller than the 1 subframe may indicate 1 Orthogonal Frequency Division Multiplexing (OFDM) symbol. In this case, the downlink control channel and the downlink data channel may be received in the same symbol.

Further, the terminal processing unit 1802 may operate to decode the downlink data channel from the next frequency resource of the last frequency resource on which the downlink control channel is mapped in the same symbol.

Further, the terminal processing unit 1802 may operate to confirm the indication information that indicates the location at which the downlink control information and the downlink data channel are divided and to decode the downlink data channel based on the indication information.

Further, the control unit may control the terminal processing unit 1802 to confirm the information that indicates the resource allocation location of the downlink data channel from the downlink control information and to decode the downlink data channel based on the information. The information may indicate the resource allocation location for the terminal in the downlink data region that is divided into n portions that correspond to the maximum number of schedulable terminals.

The terminal processing unit 1802 may control a series of processes so that the terminal can operate according to the embodiment of the present invention as described above.

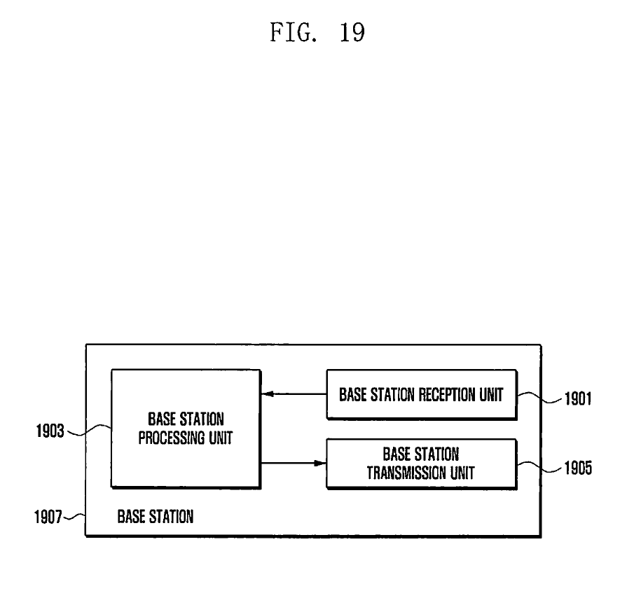

FIG. 19 is a block diagram illustrating the configuration of a base station according to an embodiment of the present invention. Referring to FIG. 19, a base station 1907 according to the present invention may include a base station reception unit 1901, a base station transmission unit 1905, and a base station processing unit 1903.

The base station reception unit 1901 and the base station transmission unit 1905 may be commonly called a transceiver unit. The transceiver unit may transmit/receive signals with a terminal. The signal may include at least one of control information, data, and pilot. The base station processing unit 1903 may be called a control unit or a controller.

The transceiver unit may include an RF transmitter configured to up-convert and amplify the frequency of the transmitted signal, and an RF receiver configured to low-noise-amplify the received signal and to down-convert the frequency. Further, the transceiver unit may receive the signal through a wireless channel, output the received signal to the base station processing unit 1903, and transmit the signal output from the base station processing unit 1903 through a wireless channel.

According to an embodiment of the present invention, the base station processing unit 1903 sets a Transmission Timing Interval (111) that is smaller than 1 subframe, generates a downlink control channel for the at least one terminal, performs mapping of the downlink data channel that corresponds to the downlink control channel based on the resource mapping location of the downlink control channel, and transmits a signal that corresponds to the TTI that is smaller than the 1 subframe on which the downlink control channel and the downlink data channel are mapped The TTI that is smaller than the 1 subframe may be called a first TTI.

The TTI that is smaller than the 1 subframe may indicate 1 Orthogonal Frequency Division Multiplexing (OFDM) symbol. In this case, the downlink control channel and the downlink data channel may be transmitted in the same symbol.

Further, the base station processing unit 1903 may perform mapping of indication information that indicates a location at which the downlink control information and the downlink cloth channel are divided.

Further, the base station processing unit 1903 may perform mapping of the downlink data channel from the next frequency resource of the last frequency resource on which the downlink control channel is mapped in the same symbol.

Further, the base station processing unit 1903 may operate to set the maximum number n of schedulable terminals in the TTI that is smaller than the first subframe, and to divide the downlink data region into n portions based on the maximum number n of the schedulable terminals. The downlink control information for a specific terminal may include information that indicates a resource allocation location for the specific terminal in the n-divided downlink data region.

The base station processing unit 1903 may control a series of processes so that the base station can operate according to the embodiment of the present invention as described above.

Meanwhile, preferred embodiments of the present invention disclosed in this specification and drawings and specific terms used therein are illustrated to present only specific examples in order to clarify the technical contents of the present invention and help understanding of the present invention, but are not intended to limit the scope of the present invention. It will be evident to those skilled in the art that various implementations based on the technical spirit of the present invention are possible in addition to the disclosed embodiments.

1. A method for transmitting/receiving a signal of a base station in a wireless communication system, comprising:
setting a first Transmission Timing Interval (TTI) in at least one terminal;
generating a downlink control channel for the at least one terminal;
mapping a downlink data channel that corresponds to the downlink control channel based on a resource mapping location of the downlink control channel; and
transmitting a signal that corresponds to the first TTI in which the downlink control channel and the downlink data channel are mapped on each other.

2. The method of claim 1, wherein the first TTI indicates 1 Orthogonal Frequency Division Multiplexing (OFDM) symbol.

3. The method of claim 1, wherein the mapping performs mapping of the downlink data channel from a frequency resource next to a last frequency resource on which the downlink control channel is mapped in the same symbol.

4. The method of claim 1, wherein the mapping comprises mapping indication information that indicates a location at which the downlink control information and the downlink data channel are divided.

5. A base station in a wireless communication system, comprising:
a transceiver unit configured to transmit and receive a signal; and
a control unit configured to set a first Transmission Timing Interval (TTI) in at least one terminal, to generate a downlink control channel for the at least one terminal, to perform mapping of a downlink data channel that corresponds to the downlink control channel based on a resource mapping location of the downlink control channel, and to transmit a signal that corresponds to the first TTI in which the downlink control channel and the downlink data channel are mapped on each other.

6. The base station of claim 5, wherein the control unit performs mapping of the downlink data channel from a frequency resource next to a last frequency resource on which the downlink control channel is mapped in the same symbol.

7. The base station of claim 5, wherein the control unit performs mapping of indication information that indicates a location at which the downlink control information and the downlink data channel are divided.

8. The base station of claim 5, wherein the control unit operates to set a maximum number n of schedulable terminals in the first TTI and to divide a downlink data region into n portions based on the maximum number n of the schedulable terminals, and
downlink control information for a specific terminal includes information that indicates a resource allocation location for the specific terminal in the n-divided downlink data region.

9. A method for transmitting/receiving a signal of a terminal in a wireless communication system, comprising:
setting a first Transmission Timing Interval (TTI);
receiving a signal that corresponds to the first TTI;
confirming a downlink control channel for a downlink data channel from the first signal; and
decoding the downlink data channel based on a resource mapping location of the downlink control channel if the downlink control channel is confirmed.

10. The method of claim 9, wherein the decoding decodes the downlink data channel from a frequency resource next to a last frequency resource on which the downlink control channel is mapped in the same symbol.

11. The method of claim 9, further comprising confirming indication information that indicates a location at which the downlink control information and the downlink data channel are divided,
wherein the downlink data channel is decoded based on the indication information.

12. A terminal in a wireless communication system, comprising:
a transceiver unit configured to transmit and receive a signal; and
a control unit configured to set a first Transmission Timing Interval (TTI), to receive a signal that corresponds to the first TTI, to confirm a downlink control channel for a downlink data channel from the signal that corresponds to the first TTI, and to decode the downlink data channel based on a resource mapping location of the downlink control channel if the downlink control channel is confirmed.

13. The terminal of claim 12, wherein the control unit decodes the downlink data channel from a frequency resource next to a last frequency resource on which the downlink control channel is mapped in the same symbol.

14. The terminal of claim 12, wherein the control unit confirms indication information that indicates a location at which the downlink control information and the downlink data channel are divided, and
decodes the downlink data channel based on the indication information.

15. The terminal of claim 12, wherein the control unit operates to confirm information that indicates a resource allocation location of the downlink data channel from the downlink control information, and decodes the downlink data channel based on the information, and
the information is information that indicates a resource allocation location for the terminal in a downlink data region that is divided into n that is the maximum number of schedulable terminals.
